(19) United States
(12) Patent Application Publication
(10) Pub. No.: US 2017/0307239 A1
(43) Pub. Date: Oct. 26, 2017

(54) LOCATION-BASED INFORMATION RETRIEVAL, VIEWING, AND DIAGNOSTICS FOR REFRIGERATION, HVAC, AND OTHER BUILDING SYSTEMS

(71) Applicant: Emerson Climate Technologies Retail Solutions, Inc., Kennesaw, GA (US)

(72) Inventors: John WALLACE, Acworth, GA (US); Franklin BELTRAN, Acworth, GA (US); Anthony CONTRADA, Kennesaw, GA (US)

(73) Assignee: Emerson Climate Technologies Retail Solutions, Inc., Kennesaw, GA (US)

(21) Appl. No.: 15/494,132

(22) Filed: Apr. 21, 2017

Related U.S. Application Data
(60) Provisional application No. 62/327,215, filed on Apr. 25, 2016.

(51) Int. Cl. F24F 11/00; F25D 29/00; G05B 19/048

(52) U.S. Cl. CPC F24F 11/006; F24F 11/0086; F25D 29/00; G05B 19/048; F24F 2011/0071; F24F 2011/0067; F24F 2011/0072; F25D 2400/361; G05B 2219/2614; F24F 2011/0091

(57) ABSTRACT

A system and method is provided that includes a system controller for a refrigeration or HVAC system having at least one system component, at least one transmitter beacon associated with the at least one system component and configured to broadcast a signal with information identifying the associated at least one system component, and a mobile device configured to receive the signal. The mobile device is further configured to identify the at least one system component that is closest to the mobile device based on the information from the signal identifying the associated at least one system component and retrieve at least one of configuration and operational data associated with the at least one system component based on the information from the signal identifying the associated at least one system component through communication with a server that is in communication with the system controller.

### CROSS-REFERENCE TO RELATED APPLICATIONS

This application claims the benefit of U.S. Provisional Application No. 62/327,215, filed on Apr. 25, 2016. The entire disclosure of the above applications is incorporated herein by reference.

### FIELD

The present disclosure relates to refrigeration, HVAC, and other building systems and, more particularly, to location-based information retrieval, viewing, and diagnostics for refrigeration, HVAC, and other building systems.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Refrigeration systems are an essential part of many commercial buildings and dwellings. For example, food retailers may rely on refrigeration systems to ensure the quality and safety of food products. Many other businesses may have products or materials that must be refrigerated or maintained at a lowered temperature. HVAC systems allow people to remain comfortable where they shop, work or live.

Refrigeration system operation, however, can represent a significant portion of a business' operating costs. As such, it may be beneficial for refrigeration system users to remotely monitor the performance and energy consumption of the refrigeration systems to detect and diagnose any performance issues so that maintenance can be performed to maximize efficiency and reduce operational costs.

### SUMMARY

This section provides a general summary of the disclosure, and is not a comprehensive disclosure of its full scope or all of its features.

A system is provided and includes a system controller for a refrigeration or HVAC system having at least one system component. The system also includes at least one transmitter beacon associated with the at least one system component and configured to broadcast a signal with information identifying the associated at least one system component. The system also includes a mobile device configured to receive the signal, identify the at least one system component that is closest to the mobile device based on the information from the signal identifying the associated at least one system component, and retrieve at least one of configuration and operational data associated with the at least one system component based on the information from the signal identifying the associated at least one system component through communication with a server that is in communication with the system controller.

In other features, the mobile device is configured to modify the configuration data of the at least one system component of the HVAC or refrigeration system.

In other features, the configuration data includes a setpoint for the at least one system component.

In other features, the signal broadcasted by the at least one transmitter beacon is a radio frequency signal utilizing a predetermined protocol.

In other features, the mobile device is configured to receive performance data of the at least one system component.

In other features, the mobile device is configured to receive a diagnostic report of the at least one system component, and the diagnostic report includes at least one of a health indicator score, a predicted power consumption, a benchmark power consumption, a floodback condition, a predicted performance issue, and a predicted capacity issue.

A method is provided and includes broadcasting, with at least one transmitter beacon associated with at least one system component of a refrigeration or HVAC system, a signal with information identifying the associated at least one system component. The method also includes receiving, with a mobile device, the signal. The method also includes identifying, with the mobile device, the at least one system component that is closest to the mobile device based on the information from the signal identifying the associated at least one system component. The method also includes retrieving, with the mobile device, at least one of configuration and operational data associated with the at least one system component based on the information from the signal identifying the associated at least one system component through communication with a server that is in communication with a system controller of the refrigeration or HVAC system.

In other features, the method also includes modifying, with the mobile device, the configuration data of the at least one system component of the HVAC or refrigeration system.

In other features, the configuration data includes a setpoint for the at least one system component.

In other features, the method the signal broadcasted by the at least one transmitter beacon is a radio frequency signal utilizing a predetermined protocol.

In other features, the method also includes receiving, with the mobile device, performance data of the at least one system component.

In other features, the method also includes receiving, with the mobile device, a diagnostic report of the at least one system component, and the diagnostic report includes at least one of a health indicator score, a predicted power consumption, a benchmark power consumption, a floodback condition, a predicted performance issue, and a predicted capacity issue.

Another system is provided and includes a system controller for a refrigeration or HVAC system having at least one system component. The system also includes a server that is in communication with the system controller and is configured to store at least one of configuration and operational data associated with the at least one system component. The system also includes a mobile device having a camera, wherein the camera is configured to capture an image of at least one of the at least one system component, indicia associated with the at least one system component, and an ID tag of the at least one system component, and, in response to the camera capturing the image, the mobile device is configured to (i) identify a first system component of the at least one system component based on the image, and (ii) retrieve, from the server, the at least one of the configuration and the operational data associated with the first system component.

In other features, the mobile device is configured to modify the configuration data of the first system component of the HVAC or refrigeration system.

In other features, the configuration data includes a setpoint for the first system component.

In other features, the mobile device is configured to receive performance data of the first system component.

In other features, the mobile device is configured to receive a diagnostic report of the first system component, and the diagnostic report includes at least one of a health indicator score, a predicted power consumption, a benchmark power consumption, a floodback condition, a predicted performance issue, and a predicted capacity issue.

In other features, the mobile device includes a computer vision system that is configured to analyze the image and identify the first system component based on the image.

Another method is provided and includes storing, using a server that is in communication with a system controller, at least one of configuration and operational data associated with at least one system component of a refrigeration or HVAC system. The method also includes capturing, using a camera of a mobile device, an image of at least one of the at least one system component, indicia associated with the at least one system component, and an ID tag of the at least one system component. The method also includes identifying, in response to capturing the image, a first system component of the at least one system component based on the image. The method also includes retrieving, with the mobile device and from the server, the at least one of the configuration and the operational data associated with the first system component.

In other features, the method also includes modifying the configuration data of the first system component of the HVAC or refrigeration system.

In other features, the configuration data includes a setpoint for the first system component.

In other features, the mobile device is configured to receive performance data of the first system component.

In other features, the mobile device is configured to receive a diagnostic report of the first system component, and wherein the diagnostic report includes at least one of a health indicator score, a predicted power consumption, a benchmark power consumption, a floodback condition, a predicted performance issue, and a predicted capacity issue.

In other features, the mobile device includes a computer vision system that is configured analyze the image and identify the first system component based on the image.

Another system is provided and includes a system controller for a refrigeration or HVAC system having at least one system component, wherein the system controller is in communication with a server. The system also includes a reference transceiver system that is configured to (i) receive a location signal from a mobile device, (ii) determine a location of the mobile device based on the location signal, and (iii) broadcast a position signal with information corresponding to the location of the mobile device to the server, wherein the server is in communication with the mobile device. The mobile device is configured to (i) identify a first system component of the at least one system component based on the information from the position signal, wherein the first system component is closest to the mobile device, and (ii) retrieve, from the server, at least one of configuration and operational data associated with the first system component.

In other features, each system component of the at least one system component further comprises a transmitter beacon that is configured to broadcast an identification signal with information identifying the associated at least one system component.

In other features, the reference transceiver system is configured to (i) receive the identification signal from each transmitter beacon, (ii) determine a location of each system component of the at least one system component based on the identification signal from each transmitter beacon, and (iii) broadcast a system position signal to the server, wherein the system position signal includes information corresponding to the location of each system component of the at least one system component.

In other features, the mobile device is configured to (i) identify the first system component of the at least one system component based on the information from each system position signal.

In other features, the mobile device is configured to modify the configuration data of the first system component of the HVAC or refrigeration system.

In other features, the configuration data includes a setpoint for the first system component.

In other features, the location signal broadcasted by the reference transceiver system is a radio frequency signal utilizing a predetermined protocol.

In other features, the mobile device is configured to receive performance data of the first system component.

In other features, the mobile device is configured to receive a diagnostic report of the at least one system component, and the diagnostic report includes at least one of a health indicator score, a predicted power consumption, a benchmark power consumption, a floodback condition, a predicted performance issue, and a predicted capacity issue.

Another method is provided and includes transmitting, using a mobile device, a location signal to a reference transceiver system. The method also includes determining, using the reference transceiver system, a location of the mobile device based on the location signal. The method also includes broadcasting, using the reference transceiver system, a position signal with information corresponding to the location of the mobile device to a server. The method also includes identifying, with the mobile device, a first system component of at least one system component based on the information from the position signal, wherein the first system component is closest to the mobile device. The method also includes retrieving, from the server and using the mobile device that is in communication with the server, at least one of configuration and operational data associated with the first system component based on the information from the position signal identifying the associated first system component.

In other features, the method also includes broadcasting, using at least one transmitter beacon that is associated with each of the at least one system component, an identification signal with information identifying a corresponding system component of the at least one system component.

In other features, the method also includes receiving, using the reference transceiver system, the identification signal from each transmitter beacon. The method also includes determining, using the reference transceiver system, a location of each system component of the at least one system component based on the identification signal from each transmitter beacon. The method also includes broadcasting, using the reference transceiver system, a system position signal for each system component of to the server, wherein the system position signal includes information corresponding to the location of each system component of the at least one system component.

In other features, the method also includes identifying, using the mobile device, the first system component of the at least one system component based on the information from the system position signal.

In other features, the method also includes modifying, with the mobile device, the configuration data of the at least one system component of an HVAC or refrigeration system.

In other features, the configuration data includes a setpoint for the first system component.

In other features, the location signal broadcasted by the reference transceiver system is a radio frequency signal utilizing a predetermined protocol.

In other features, the method also includes receiving, with the mobile device, performance data of the first system component.

In other features, the method also includes receiving, with the mobile device, a diagnostic report of the first system component, wherein the diagnostic report includes at least one of a health indicator score, a predicted power consumption, a benchmark power consumption, a floodback condition, a predicted performance issue, and a predicted capacity issue.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a block diagram of an example refrigeration system according to the present disclosure.

FIG. 2 is a flowchart of example operation in performing and storing a diagnostic analysis of a refrigeration unit according to the present disclosure.

FIG. 3A is a high level diagram of an example embodiment of the location-based diagnostic view system according to the present disclosure.

FIG. 3B is an example embodiment of a default app state of an App that is used to receive and display the performance and operation data from the server of the refrigeration system according to the present disclosure.

FIG. 3C is an example embodiment of a search results app state of an App that is used to receive and display the performance and operation data from the server of the refrigeration system according to the present disclosure.

FIG. 3D is an example embodiment of a diagnostic report app state of an App that is used to receive and display the performance and operation data from the server of the refrigeration according to the present disclosure.

FIG. 3E is a flowchart of example operation in providing a diagnostic report of a refrigeration unit to a mobile device according to the present disclosure.

FIG. 4A is a high level diagram of an example embodiment of the location-based diagnostic view system according to the present disclosure.

FIG. 4B is an example embodiment of a default app state of an App that is used to receive and display the performance and operation data from the refrigeration system according to the present disclosure.

FIG. 4C is an example embodiment of a case image app state of an App that is used to receive and display the performance and operation data from the refrigeration system according to the present disclosure.

FIG. 4D is an example embodiment of a default app state of an App that is used to receive and display the performance and operation data from the refrigeration system according to the present disclosure.

FIG. 4E is an example embodiment of a case ID app state of an App that is used to receive and display the performance and operation data from the refrigeration system according to the present disclosure.

FIG. 4F is an example embodiment of a diagnostic report app state of an App that is used to receive and display the performance and operation data from the server of the refrigeration according to the present disclosure.

FIG. 4G is a flowchart of example operation in providing a diagnostic report of a refrigeration unit to a mobile device according to the present disclosure.

FIG. 5A is a high level diagram of an example embodiment of the location-based diagnostic view system according to the present disclosure.

FIG. 5B is an example embodiment of a default app state of an App that is used to receive and display the performance and operation data from the server of the refrigeration system according to the present disclosure.

FIG. 5C is an example embodiment of a diagnostic report app state of an App that is used to receive and display the performance and operation data from the server of the refrigeration according to the present disclosure.

FIG. 5D is a flowchart of example operation in providing a diagnostic report of a refrigeration unit to a mobile device according to the present disclosure.

FIG. 6A is a high level diagram of an example embodiment of the location-based diagnostic view system according to the present disclosure.

FIG. 6B is an example embodiment of a default app state of an App that is used to receive and display the performance and operation data from the server of the refrigeration system according to the present disclosure.

FIG. 6C is an example embodiment of a diagnostic report app state of an App that is used to receive and display the performance and operation data from the server of the refrigeration according to the present disclosure.

FIG. 6D is a flowchart of example operation in providing a diagnostic report of a refrigeration unit to a mobile device according to the present disclosure.

Corresponding reference numerals indicate corresponding parts throughout the several views of the drawings.

### DETAILED DESCRIPTION

Example embodiments will now be described more fully with reference to the accompanying drawings.

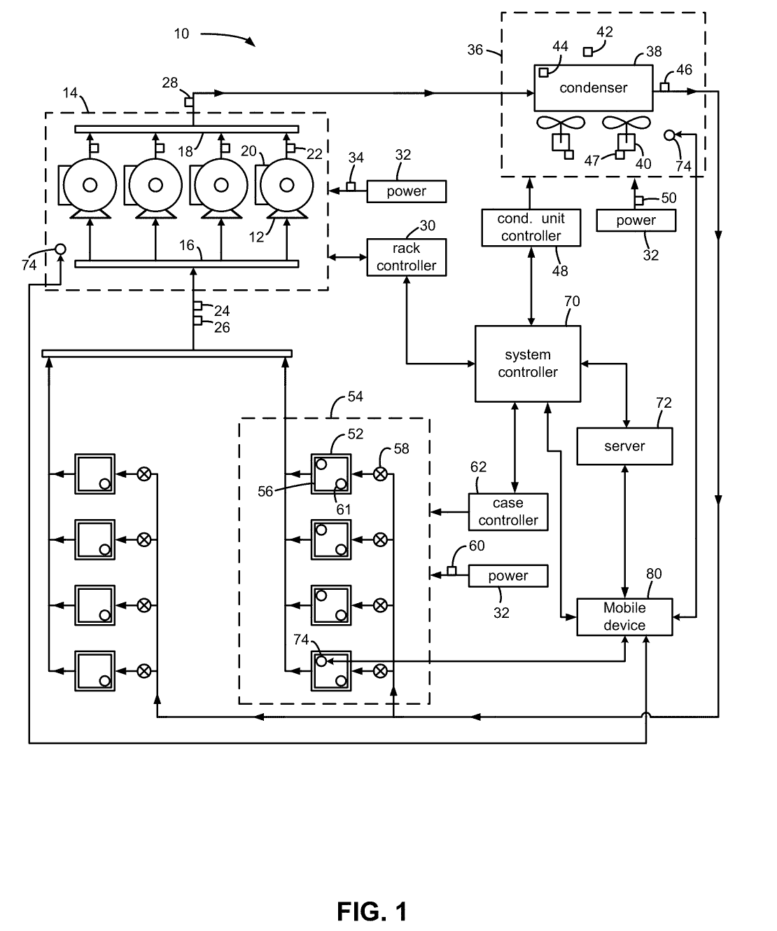

With reference to FIG. 1, an exemplary refrigeration system 10 is shown and includes a plurality of compressors 12 piped together in a compressor rack 14 with a common suction manifold 16 and a discharge header 18. While FIG. 1 shows an example refrigeration system 10, the teachings of the present disclosure also apply, for example, to HVAC systems.

Each compressor 12 has an associated compressor controller 20 that monitors and controls operation of the compressor 12. For example, the compressor controller 20 may monitor electric power, voltage, and/or current delivered to the compressor 12 with a power sensor, a voltage sensor, and/or a current sensor. Further, the compressor controller 20 may also monitor suction or discharge temperatures or pressures of the compressor 12 with suction or discharge temperature or pressure sensors. For example, a discharge outlet of each compressor 12 can include a respective discharge temperature sensor 22. A discharge pressure sensor can be used in addition to, or in place of, the discharge temperature sensor 22. An input to the suction manifold 16 can include both a suction pressure sensor 24 and a suction temperature sensor 26. Further, a discharge outlet of the discharge header 18 can include an associated discharge pressure sensor 28. A discharge temperature sensor can be used in addition to, or in place of, the discharge pressure sensor 28. As described in further detail below, the various sensors can be implemented for monitoring performance and diagnosing the compressors 12 in the compressor rack 14.

A rack controller 30 may monitor and control operation of the compressor rack 14 via communication with each of the compressor controllers 20. For example, the rack controller 30 may instruct individual compressors 12 to turn on or turn off through communication with the compressor controllers 20. Additionally, the rack controller 30 may instruct variable capacity compressors to increase or decrease capacity through communication with the compressor controllers 20. In addition, the rack controller 30 may receive data indicating the electric power, voltage, and/or current delivered to each of the compressors 12 from the compressor controllers 20. Further, the rack controller 30 may also receive data indicating the suction or discharge temperatures or pressures of each of the compressors 12 from the compressor controllers 20. Additionally or alternatively, the rack controller 30 may communicate directly with the suction or discharge temperature or pressure sensors to receive such data. Additionally, the rack controller 30 may be in communication with other suction and discharge temperature and pressure sensors, including, for example, discharge pressure sensor 28, suction pressure sensor 24, and suction temperature sensor 26.

Electric power may be delivered to the compressor rack 14 from a power supply 32 for distribution to the individual compressors 12. A rack power sensor 34 may sense the amount of power delivered to the compressor rack 14. A current sensor or a voltage sensor may be used in place of or in addition to the rack power sensor 34. The rack controller 30 may communicate with the rack power sensor 34 and monitor the amount of power delivered to the compressor rack 14. Alternatively, the rack power sensor 34 may be omitted and the total power delivered to the compressor rack 14 may be determined based on the power data for the power delivered to each of the individual compressors 12 as determined by the compressor controllers 20.

The compressor rack 14 compresses refrigerant vapor that is delivered to a condensing unit 36 having a condenser 38 where the refrigerant vapor is liquefied at high pressure. Condenser fans 40 may enable improved heat transfer from the condenser 38. The condensing unit 36 can include an associated ambient temperature sensor 42, a condenser temperature sensor 44, and/or a condenser discharge pressure sensor 46. Each of the condenser fans 40 may include a condenser fan power sensor 47 that senses the amount of power delivered to each of the condenser fans 40. A current sensor or a voltage sensor may be used in place of or in addition to the condenser fan power sensor 47.

A condensing unit controller 48 may monitor and control operation of the condenser fans 40. For example, the condensing unit controller 48 may turn on or turn off individual condenser fans 40 and/or increase or decrease capacity of any variable speed condenser fans 40. In addition, the condensing unit controller 48 may receive data indicating the electric power delivered to each of the condenser fans 40 through communication with the condenser fan power sensors 47. Additionally, the condensing unit controller 48 may be in communication with the other condensing unit sensors, including, for example, the ambient temperature sensor 42, the condenser temperature sensor 44, and the condenser discharge pressure sensor 46.

Electric power may be delivered to the condensing unit 36 from the power supply 32 for distribution to the individual condenser fans 40. A condensing unit power sensor 50 may sense the amount of power delivered to the condensing unit 36. A current sensor or a voltage sensor may be used in place of or in addition to the condensing unit power sensor 50. The condensing unit controller 48 may communicate with the condensing unit power sensor 50 and monitor the amount of power delivered to the condensing unit 36.

The high-pressure liquid refrigerant from the condensing unit 36 may be delivered to refrigeration cases 52. For example, refrigeration cases 52 may include a group 54 of refrigeration cases 52. The refrigeration cases 52 may be refrigerated or frozen food cases at a grocery store, for example. Each refrigeration case 52 may include an evaporator 56 and an expansion valve 58 for controlling the superheat of the refrigerant and an evaporator temperature sensor 61. The refrigerant passes through the expansion valve 58 where a pressure drop causes the high pressure liquid refrigerant to achieve a lower pressure combination of liquid and vapor. As hot air from the refrigeration case 52 moves across the evaporator 56, the low pressure liquid turns into gas. The low pressure gas is then delivered back to the compressor rack 14, where the refrigeration cycle starts again.

A case controller 62 may monitor and control operation of the evaporators 56 and/or the expansion valves 58. For example, the case controller 62 may turn on or turn off evaporator fans of the evaporators 54 and/or increase or decrease capacity of any variable speed evaporator fans. The case controller 62 may be in communication with the evaporator temperature sensor 61 and receive evaporator temperature data.

Electric power may be delivered to the group 54 of refrigeration cases 52 from the power supply 32 for distribution to the individual condenser fans 40. A refrigeration case power sensor 60 may sense the amount of power delivered to the group 54 of refrigeration cases 52. A current sensor or a voltage sensor may be used in place of or in addition to the refrigeration case power sensor 60. The case controller 62 may communicate with the refrigeration case power sensor 60 and monitor the amount of power delivered to the group 54 of refrigeration cases 52.

As discussed above, while FIG. 1 shows an example refrigeration system 10, the teachings of the present disclosure also apply, for example, to HVAC systems, including, for example, air conditioning and heat pump systems. In the example of an HVAC system, the evaporators 56 would be installed in air handler units instead of in refrigeration cases 52.

A system controller 70 monitors and controls operation of the entire refrigeration system 10 through communication with each of the rack controller 30, condensing unit controller 48, and the case controller 62. Alternatively, the rack controller 30, condensing unit controller 48, and/or case controller 62 could be omitted and the system controller 70 could directly control the compressor rack 14, condensing unit 36, and/or group 54 of refrigeration cases 52. The system controller 70 can receive the operation data of the refrigeration system 10, as sensed by the various sensors, through communication with the rack controller 30, condensing unit controller 48, and/or case controller 62. For example, the system controller can receive data regarding the various temperatures and pressures of the system and regarding electric power, current, and/or voltage delivered to the various system components. Alternatively, some or all of the various sensors may be configured to communicate directly with the system controller 70. For example, the ambient temperature sensor 42 may communicate directly with the system controller 70 and provide ambient temperature data.

The system controller 70 may coordinate operation of the refrigeration system, for example, by increasing or decreasing capacity of various system components. For example, the system controller 70 may instruct the rack controller 30 to increase or decrease capacity by activating or deactivating a compressor 12 or by increasing or decreasing capacity of a variable capacity compressor. The system controller 70 may instruct the condensing unit controller 48 to increase or decrease condensing unit capacity by activating or deactivating the condenser fan 40 or by increasing or decreasing a speed of a variable speed condenser fan. The system controller 70 may instruct the case controller 62 to increase or decrease evaporator capacity by activating or deactivating an evaporator fan of an evaporator 56 or by increasing or decreasing a speed of a variable speed evaporator fan. The system controller 70 may include a computer-readable medium, such as a volatile or non-volatile memory, to store instructions executable by a processor to carry out the functionality described herein to monitor and control operation of the refrigeration system 10.

The system controller 70 may be, for example, an E2 RX refrigeration controller available from Emerson Climate Technologies Retail Solutions, Inc. of Kennesaw, Ga. If the system is an HVAC system instead of a refrigeration system, the system controller 70 may be, for example, an E2 BX HVAC and lighting controller also available from Emerson Climate Technologies Retail Solutions, Inc. of Kennesaw, Ga. Further, any other type of programmable controller that may be programmed with the functionality described in the present disclosure can also be used.

The system controller 70 can monitor the actual power consumption of the refrigeration system 10, including the compressor rack 14, the condensing unit 36, and the refrigeration cases 52, and compare the actual power consumption of the refrigeration system 10 with a predicted power consumption or with a benchmark power consumption for the refrigeration system 10 to determine a health indicator score for the refrigeration system 10 and/or for individual refrigeration system components. Additionally or alternatively, the system controller 70 can monitor the temperatures and pressures of the refrigeration system 10, including the compressor rack 14, the condensing unit 36, and the refrigeration cases 52, and compare the temperatures and/or pressures with expected temperatures and/or pressures, based, for example, on historical data to determine a health indicator score for the refrigeration system 10 and/or for individual refrigeration system components.

The system controller 70 may be in communication with a server 72. The server 72 may be, for example, configured to communicate with the system controller 70 via a remote link such as, for example, a Wi-Fi link, a Bluetooth link, a local area network at the facility location of the refrigeration systems, or a wide area network, such as the internet. Alternatively, the server 72 may be a part of the system controller 70 and may be configured to communicate with each other via a hardwire link. As an example, the system controller 70 including the server 72 may be implemented in an E2 BX HVAC and lighting controller available from Emerson Climate Technologies Retail Solutions, Inc. of Kennesaw, Ga. Alternatively, the server 72 may be implemented in a Site Supervisor controller available from Emerson Climate Technologies Retail Solutions, Inc. of Kennesaw, Ga.

The server 72 may communicate with the system controller 70 to receive and store configuration and operational data of the refrigeration system 10, including, for example, energy or performance data of the refrigeration system 10. The server 72 may further include a computer-readable medium, such as a volatile or non-volatile memory component, so that the configuration and operational data of the refrigeration system 10 may be received and stored on the server 72.

The server 72 may be in communication with a mobile device 80. The mobile device 80 may be, for example, a laptop, a tablet, a smartphone or other computing device with communication/networking capabilities. Alternatively, the mobile device 80 may be a desktop computer. The mobile device 80 may communicate with the server 72 via a local area network at the facility location of the refrigeration system 10. The mobile device 80 may also communicate with the server 72 via a wide area network, such as the internet.

The mobile device 80 may be configured to receive and display stored configuration and operational data from the server 72 for one or more refrigeration or HVAC systems or one or more components thereof, including, for example, configuration and/or operational data, such as energy or performance data for the refrigeration or HVAC systems or components. The mobile device 80 may display the stored data from the server 72 using an application (App) on the mobile device 80 that is configured to display the stored data on a graphic user interface, such as a touchscreen, of the mobile device 80.

The mobile device 80 may be in communication with the system controller 70. The mobile device 80 may communicate with the system controller 70 via a local area network at the facility location of the refrigeration system 10 or a wide area network, such as the internet. The mobile device 80 may be configured to remotely monitor the operation of the system controller 70.

The mobile device 80 may be in communication with a plurality of beacons 74, which may be coupled to and associated with individual systems or components, including, for example, each of the refrigeration cases 52, the condensing unit 36, and the compressor rack 14. The beacons 74 may be, for example, configured to communicate with the mobile device 80 via a remote link such as, for example, a Bluetooth link.

The beacon 74 may be configured to broadcast/communicate identifying information for the associated system or component to the mobile device 80. For example, the beacon 74 may communicate an identification number for the associated system or component and/or the physical location of the associated system or component, such as the refrigeration case 52, the condensing unit 36, and/or the compressor rack 14, to the mobile device 80. Alternatively or additionally, if the mobile device 80 receives a Bluetooth signal from the beacon 74, the mobile device 80 may be configured to, using an App or an operating system of the mobile device 80, execute a location-based action on the mobile device, such as retrieving configuration data, operational data, and/or diagnostics data from the server 72 of the corresponding system or component, for example the refrigeration case 52, condensing unit 36, and/or compressor rack 14, and displaying the configuration data, operational data, and/or diagnostics on the mobile device 80. For example, as discussed in further detail below, a technician may be able to move around a location, such as a retail location with multiple pieces of equipment, while holding the mobile device 80. The App running on the mobile device 80 can then receive the nearest beacon and automatically provide confirmation and/or status information for that particular piece of equipment, for example a refrigeration case or other equipment. Alternatively, the technician could manually instruct the App running on the mobile device 80 to provide the confirmation and/or status information for that particular piece of equipment.

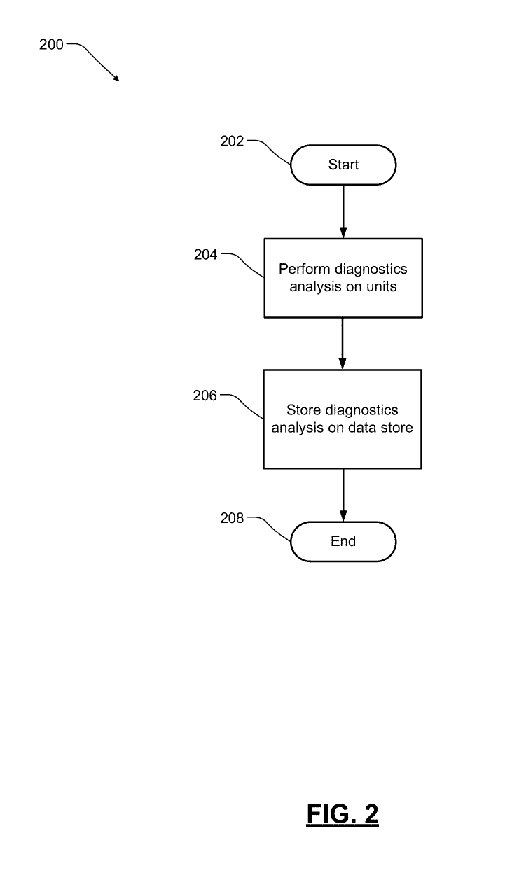

With reference to FIG. 2, a control algorithm 200 is shown for performing and storing a diagnostics analysis on a refrigeration unit. The control algorithm 200 may be performed, for example, by the system controller 70 and starts at 202. At 204, the system controller 70 performs a diagnostics analysis on the refrigeration or HVAC unit. The diagnostic analysis may include, for example, calculating a health indicator score for the refrigeration system and/or a refrigeration system component; calculating a predicted power consumption based on performance coefficients for the refrigeration system components and operational data for the refrigeration system; determining benchmark power consumption based on the refrigeration system performance during a predetermined time period, such as an initialization period; determining a floodback condition of the refrigeration system; predicting a performance or capacity issue for a future time period; and performing automatic setup operations for system components based on retrieved component information.

Systems and methods for performing the diagnostics analysis on the refrigeration systems at 204 are described in the commonly assigned U.S. patent application Ser. No. 15/197,169, U.S. Pub. No. 2017/0089598, titled “Maintenance and Diagnostics for a Refrigeration System,” which is incorporated herein by reference in its entirety.

At 206, the diagnostic analysis performed on the refrigeration unit is stored on a data store. For example, the diagnostic analysis may be stored on the computer-readable medium, such as the non-volatile memory on the server 72. The diagnostic analysis may be communicated to the server 72 via a remote link such as, for example, a local area network at the facility location of the refrigeration system, or a wide area network, such as the internet. At 208, the control algorithm 200 ends.

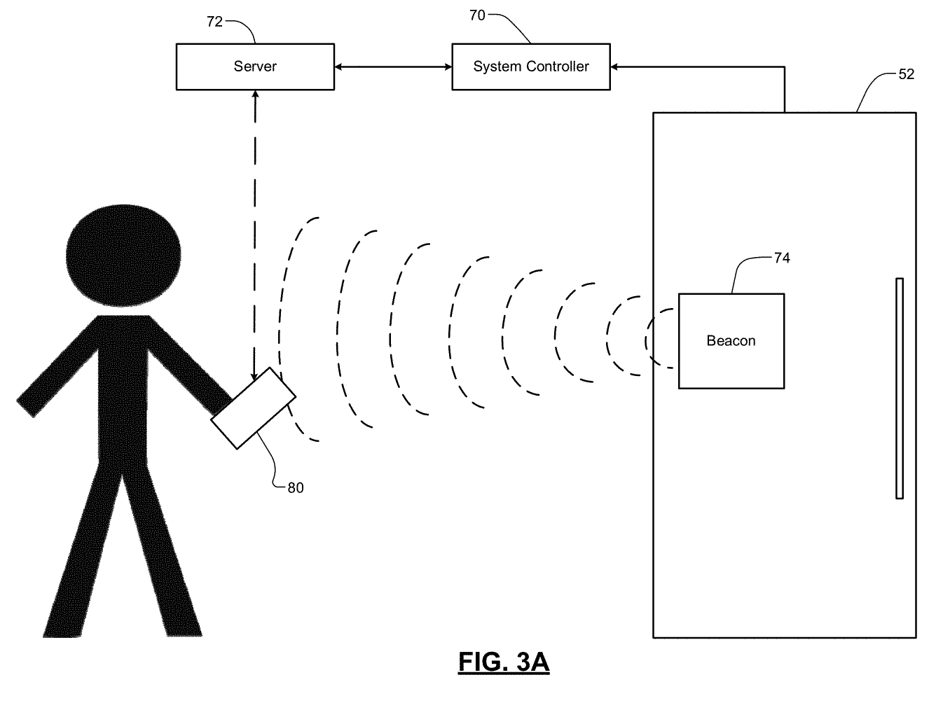

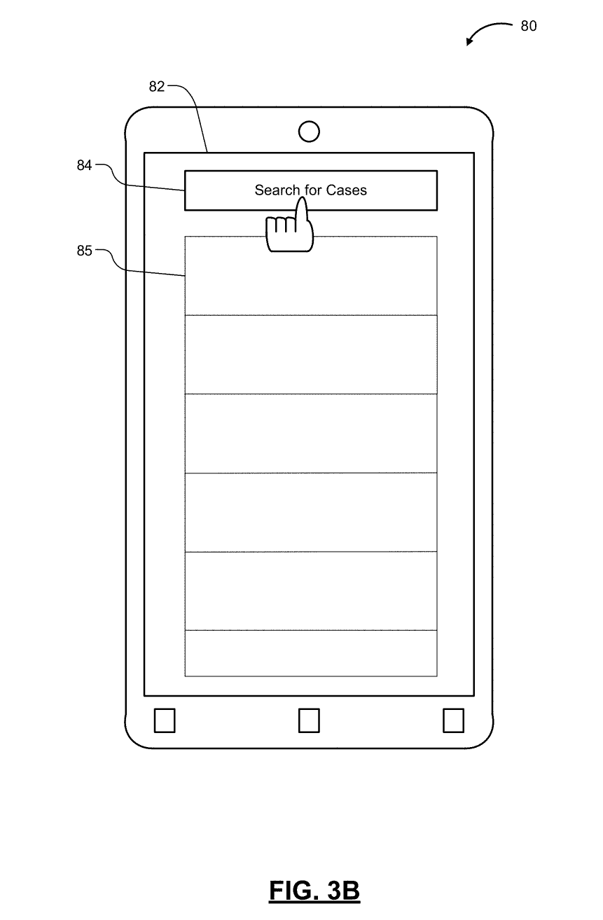

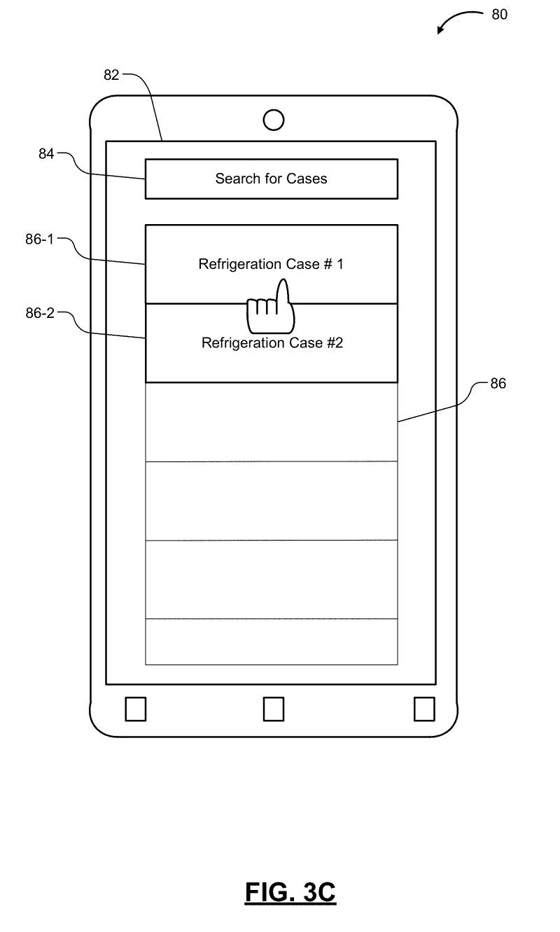

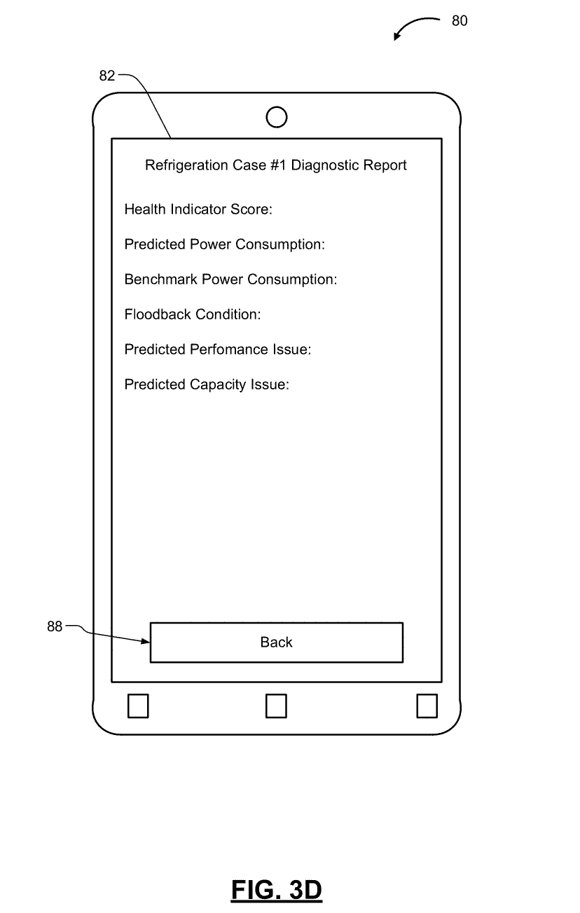

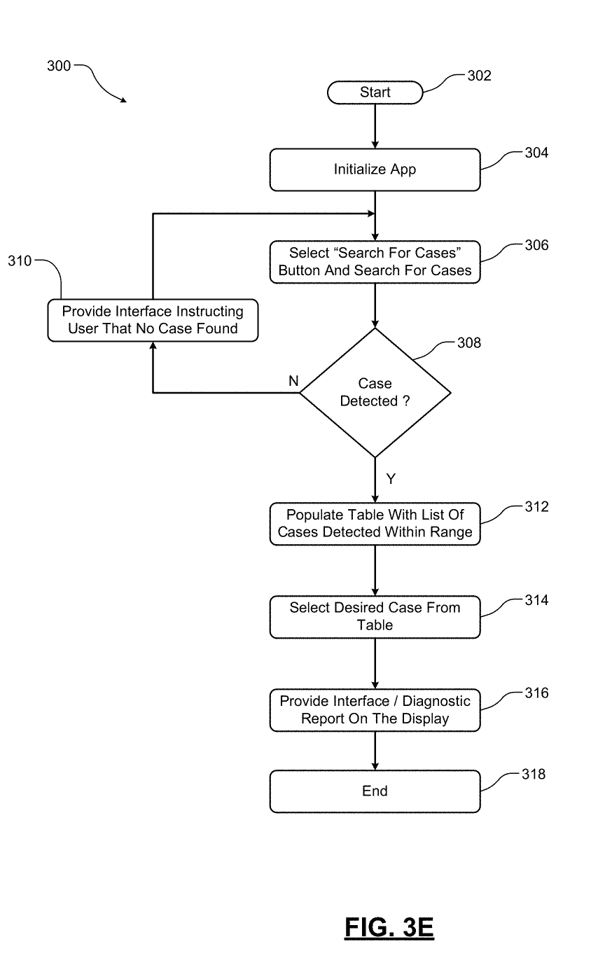

With reference to FIG. 3A, a high level diagram of an example embodiment of a location-based diagnostic view system is shown is shown. In this embodiment, the case controller 62 is omitted and the system controller 70 directly controls and monitors the refrigeration cases 52. The system controller 70, which is configured to directly communicate with various sensors, receives the operation data of the refrigeration case 52, such as the various temperatures and pressures of the system and electric power, current, and/or voltage delivered to the various system components. The server 72 then may store the operation and performance data of the refrigeration case 52 on, for example, the computer-readable medium, such as the volatile or the non-volatile memory component.

Meanwhile, the beacon 74 may transmit the identification information and/or physical location data of the refrigeration case 52 via a Bluetooth signal. The mobile device 80, which may be a smartphone in this embodiment, is configured to receive, for example, Bluetooth signals from the beacon 74. Once the mobile device 80 detects and receives the signal, for example a Bluetooth signal, from the beacon 74, the mobile device 80 is configured to, using an App, retrieve the configuration, performance, and/or operational data from the server 72 of the refrigeration case 52 and subsequently display the configuration, performance, and operational data on a display of the mobile device 80. While the beacon 74 is described as utilizing a Bluetooth signal, other signals could alternatively be use, such as radio frequency (RF) signals using alternative protocols, for example a Wi-Fi signal or a ZigBee signal.

The system controller 70 may include a user interface to view configuration, performance, and/or operational data for individual systems or components. For example, the system controller 70 may include a user interface that displays, and allows for modifications of, various setpoints and other configuration settings for individual systems or components. The mobile device 80 can be configured to, using the App, display the same, or a similar, user interface that is used and displayed by the system controller 70. As such, a user of the mobile device 80 may be able to view configuration, performance, and/or operational data of a particular system or component, and may be able to modify particular setpoints or other configuration settings for the particular system or component, as if the user were located at the system controller 70 and using the user interface of the system controller 70.

With reference to FIG. 3B, an example embodiment of a default app state of an App that is used to receive and display the configuration, performance, and/or operational data from the server of the refrigeration system is shown. In this embodiment, the mobile device 80 is a smartphone. Alternatively, a laptop, PDA, or other device of the like may be used.

The default app state of the App is shown on a display 82 of the mobile device 80. The App may be set to the default app state when the App is initialized by opening the App on the mobile device 80. The default app state is configured to provide an operator of the mobile device 80 the capability to detect refrigeration or HVAC systems located within a building or dwelling. For example, the default app state may provide a “Search for Cases” button 84 on the display 82 of the mobile device 80. Accordingly, once the operator selects button 84, as shown by a cartoon hand in FIG. 3B, the mobile device 80 searches for Bluetooth signals that are being transmitted from the plurality of beacons 74 coupled to the various components of the HVAC and refrigeration systems 10.

With reference to FIG. 3C, an example embodiment of a search results app state of an App that is used to receive and display the configuration, performance, and/or operational data from the server of the refrigeration system is shown. The App is set to the search results app state, for example, once the user has selected the “Search for Cases” button 84 in the default app state, as described in FIG. 3A. Alternatively, the App may be configured to bypass the default app state and automatically search for Bluetooth signals that are being transmitted from the plurality of beacons 74 coupled to the various components of the HVAC and refrigeration system 10 once the App has been initialized. Alternatively, the App may be configured to bypass the default app state and automatically search for components of a refrigeration or HVAC system and display the diagnostic report if a system or component is detected by the mobile device 80, thereby eliminating the need to manually perform the search query at the default app state. In this way, the technician using the App can simply walk through a location that includes various pieces of equipment while the App automatically sensed the nearest beacon and automatically displays the correct information associated with the piece of equipment without requiring further action or input from the technician, aside from opening the App and moving throughout the location in the vicinity of the various pieces of equipment.

The search results app state may be configured to populate a table 85 with a list of detected systems or components, such as compressor racks 14, condensing units 36, and refrigeration cases 52, based on the search instruction or query performed in the default app state. For example, after selecting the “Search for Cases” button 84 in the default app state, the mobile device 80 may detect Bluetooth signals from the beacons 74 of two refrigeration cases 52, which are labeled and displayed as refrigeration case #1 and #2 buttons 86-1 and 86-2 within the table 85, respectively.

Additionally, the search results app state may be configured to allow an operator of the mobile device 80 to repeat the search query. For example, if the operator is standing next to the refrigeration case 52, and the search result app state does not display any refrigeration cases 52 in the table 85, the operator has the ability to repeat the search query by selecting the “Search for Cases” button 84 on the graphic user interface of the mobile device 80.

The search app state may be configured to allow an operator of the mobile device 80 to view a diagnostic report of a detected refrigeration or HVAC system. For example, the operator may select the “Refrigeration Case #1” button 86-1 to view the diagnostic report of that refrigeration case 52, as shown by the cartoon hand in FIG. 3B. The search app state may also be configured to allow the operator of the mobile device 80 to view a user interface including setpoints and other configuration data associated with the refrigeration case 52. The operator can then modify individual setpoint settings as if the operator were using a user interface of the system controller 70 or the case controller 62.

With reference to FIG. 3D, an example embodiment of a diagnostic report app state of an App that is used to receive and display the configuration, performance, and operational data from the server of the refrigeration system is shown. The App is set to the diagnostic report app state, for example, once the user has selected the “Refrigeration Case #1” button 86-1 in the search results app state, as described in FIG. 3B. Alternatively, the App may be configured to bypass the search results app state and/or default app state and automatically display the diagnostic report if a single refrigeration or HVAC system is detected, thereby eliminating the need to select from multiple refrigeration and HVAC systems.

The diagnostic report app state may be configured to display a variety of system diagnostics, including: a health indicator score for the refrigeration system and/or a refrigeration system component; a predicted power consumption based on performance coefficients for the refrigeration system components and operational data for the refrigeration system; a benchmark power consumption based on the refrigeration system performance during a predetermined time period, such as an initialization period; a floodback condition of the refrigeration system; and a prediction of a performance or capacity issue for a future time period.

Additionally or alternatively, the diagnostic report app state may be configured to allow an operator to perform automatic setup operations for system components based on retrieved component information.

A “Back” button 88 on the display 82 of the mobile device may be configured to allow the operator to return to either the default app state or the search results app state. The operator of the mobile device 80 may select this button if he or she has selected the wrong refrigeration or HVAC unit, has reviewed the diagnostic report and performed any automatic setup operations for the system, or desires to set the App to the default app state.

With reference to FIG. 3E, a flowchart of example operation in providing an interface and diagnostic report of a refrigeration unit to a mobile device is shown. The control algorithm 300 may be performed, for example, by the mobile device 80 and starts at 302. At 304, a user of the mobile device 80 initializes the App. The user may initialize the App, for example, by selecting the App from a list of Apps on a graphic user interface of the mobile device, such as a touchscreen of the mobile device 80. Alternatively, the App may be configured to automatically initialize itself once the mobile device 80 detects a refrigeration system component with a beacon 74 within a predetermined range.

At 306, the operator selects the “Search for Cases” button 84 on the display 82, and in response, the mobile device 80 is configured to search for refrigeration system components. The mobile device 80 may begin to search for refrigeration system components by attempting to communicate with the refrigeration system components via a Bluetooth or Wi-Fi link. Alternatively, the App may be configured to automatically search for the refrigeration system components as soon as the App has been initialized by the user.

At 308, the control algorithm 300 determines whether a refrigeration system component has been detected. If the control algorithm 300 detects a refrigeration system component within its range, it proceeds to 310. Otherwise, the control algorithm 300 transfers to 310 and provides an interface on the display 82 that instructs the operator that no refrigeration system component was found. Then, the control algorithm 300 returns to 306 and repeats the search process until a refrigeration unit is detected.

At 312, the control algorithm 300 populates the table 85 on the display 82 of the mobile device 80 with a list of the detected refrigeration units. The table 85, as described above, may be populated during the search results app state. At 314, the operator of the mobile device 80 selects a refrigeration unit from the table 85. At 316, the user of the mobile device 80 is provided an interface and/or diagnostic report associated with the selected refrigeration system component. As described above, the interface and/or diagnostic report may be provided on the display 82 of the mobile device 80 at the diagnostic report app state. Alternatively, the diagnostic report may be provided at the second App state by displaying the diagnostic report underneath the selected refrigeration unit and re-indexing the remaining detected units on the table 85 accordingly. At 318, the control algorithm 300 ends.

Once the interface is displayed on the mobile device 80, the mobile device 80 may receive input from the user via the touch screen, for example, to modify configuration data, such as setpoints for the associated refrigeration system component. The modifications can then be communicated from the mobile device 80 to the server 72 and then to the system controller 70. The system controller 70 can then update the configuration data settings for the refrigeration system and the associated refrigeration system component in particular so that the system operates with the new configuration setting or settings. In this way, a user of the mobile device 80 can view and modify configuration data for a particular refrigeration system component without having to enter such modifications directly into the system controller 70 or a particular component controller, such as the rack controller 30, case controller 62, condensing unit controller 48, and/or compressor controller 20.

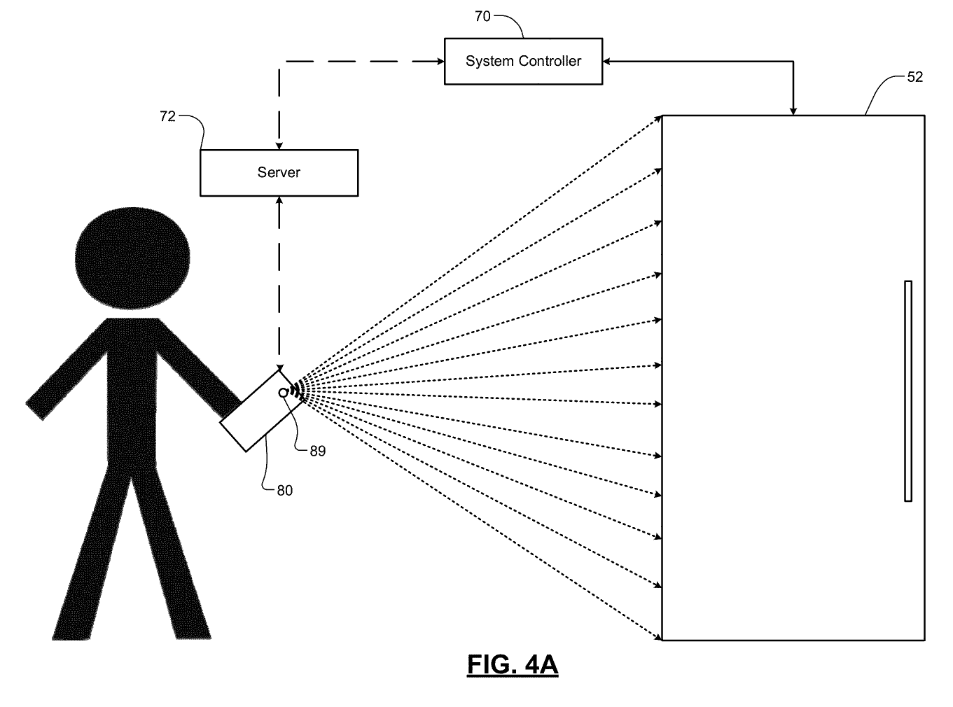

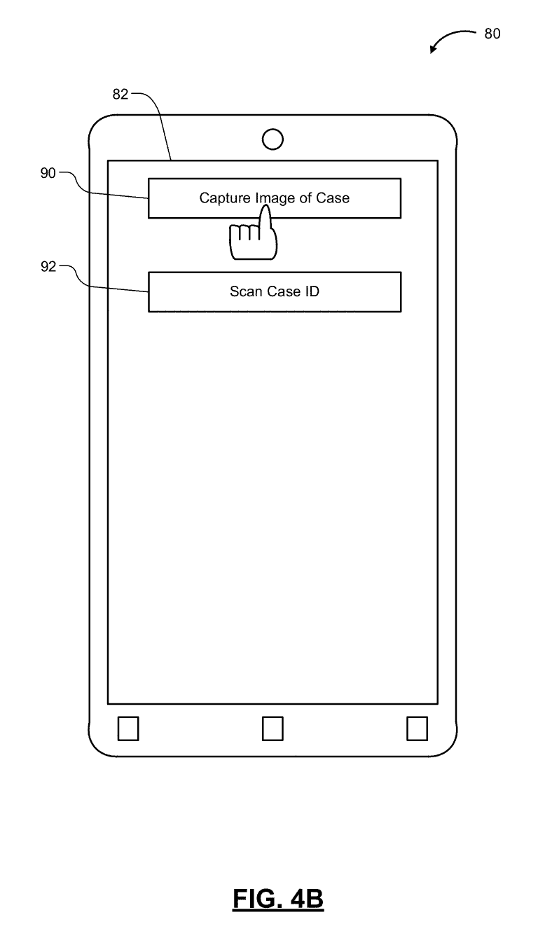

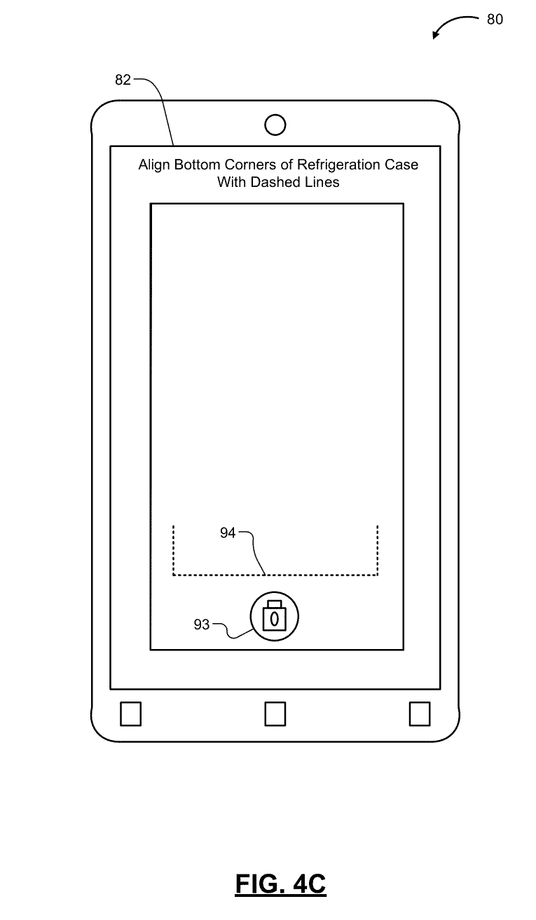

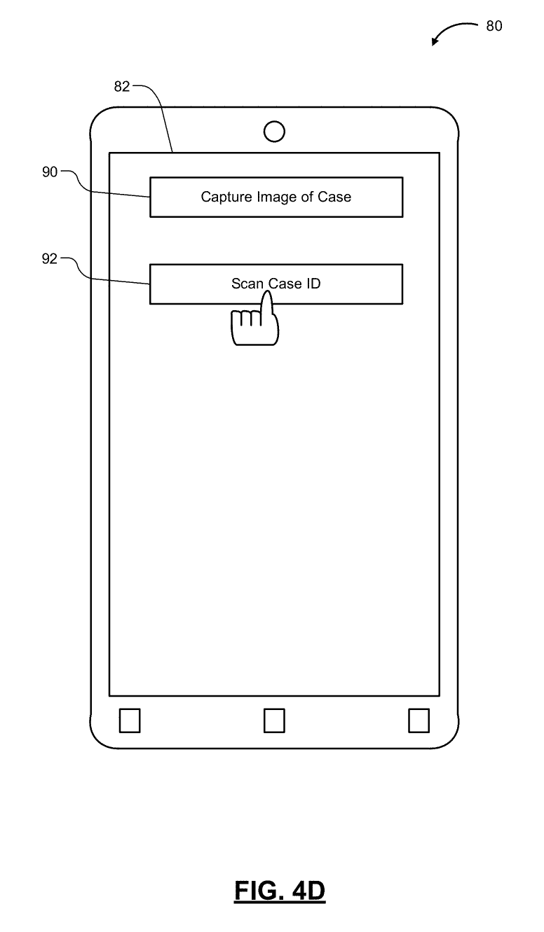

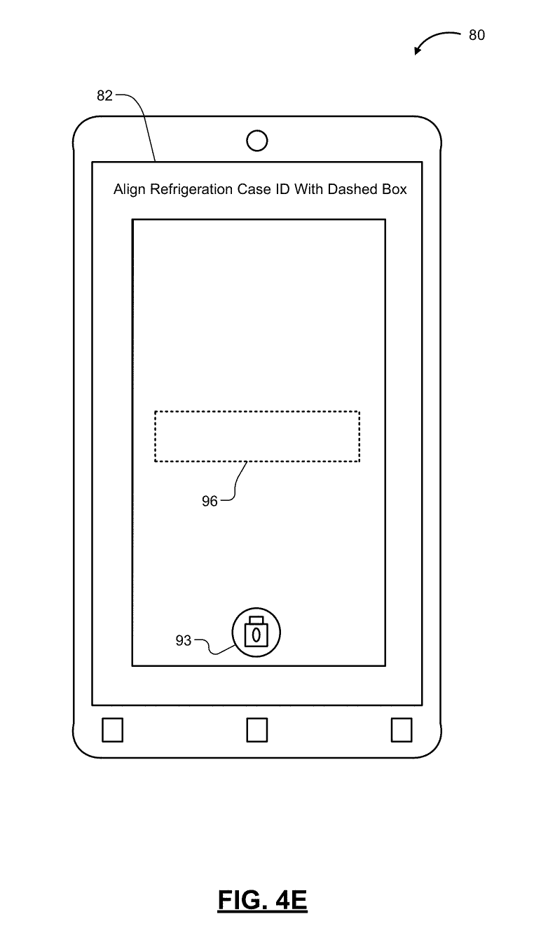

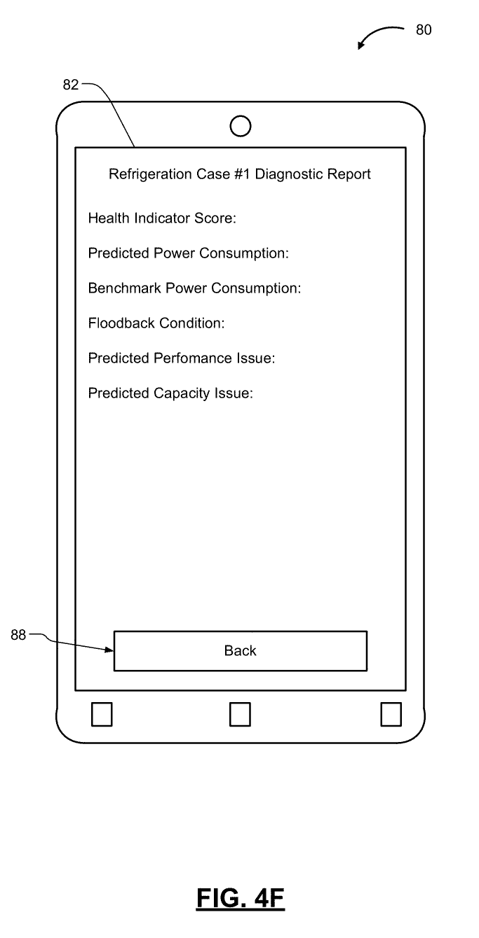

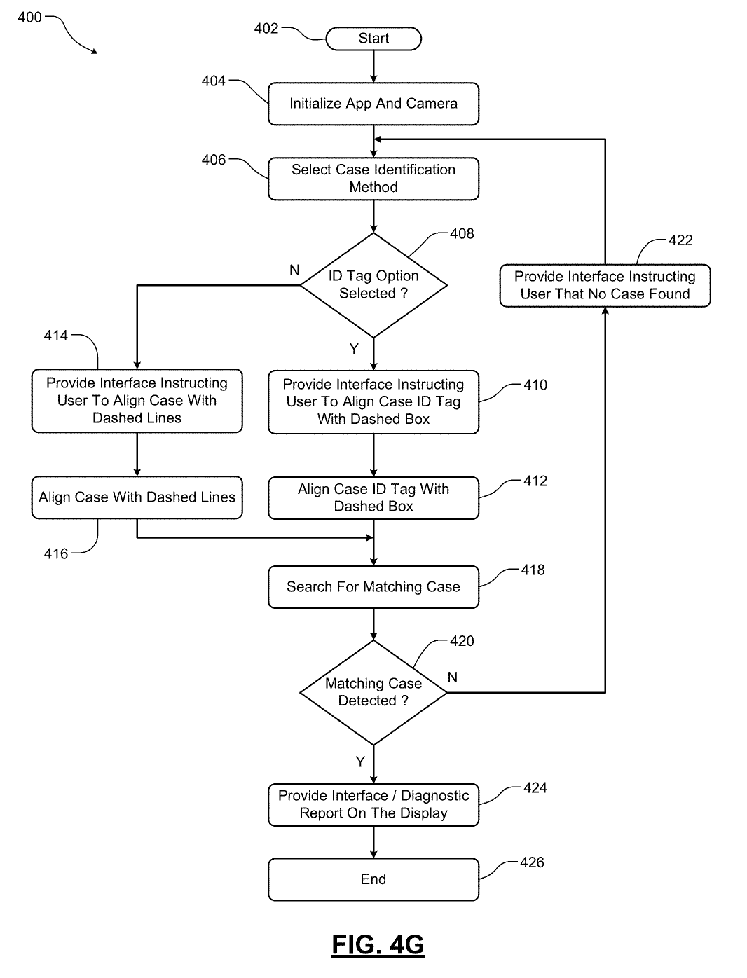

With reference to FIG. 4A, a high level diagram of another example embodiment of the location-based diagnostic view system is shown. In this embodiment, the case controller 62 is omitted and the system controller 70 directly controls and monitors the refrigeration cases 52. The system controller 70, which is configured to directly communicate with various sensors, receives the operation data of the refrigeration case 52, such as the various temperatures and pressures of the system and electric power, current, and/or voltage delivered to the various system components. The server 72, which is in communication with the system controller 70, then may store the operation and performance data of the refrigeration case 52 on, for example, a computer-readable medium, such as a volatile or the non-volatile memory component. In response to the mobile device 80 capturing an image of the refrigeration case 52 and the server 72 receiving a signal from the mobile device 80 requesting to view the configuration, performance, and operational data of the refrigeration case 52, as described below, the server 72 may be configured to transmit the configuration, performance, and operational data of the refrigeration case 52 to the mobile device 80.

The mobile device 80 may be configured to retrieve identifying information and/or physical location data of the refrigeration case 52 using a computer vision system or other system of the like located within the mobile device 80. The mobile device 80, which may be a smartphone with a camera 89, may be configured to retrieve identifying information and/or physical location data of the refrigeration case 52 when the camera 89 of the mobile device 80 captures an image of the refrigeration case 52 or other indicia associated with the refrigeration case 52 (e.g., a refrigeration rack, a lighting panel, and/or a light fixture associated with the respective refrigeration case 52). Once an image is captured by the camera 89, the mobile device 80 may be configured to, using an App that is configured to perform computer vision algorithms, process and analyze the image, thereby allowing the mobile device 80 to determine which refrigeration case 52 of the refrigeration system is being detected by the mobile device 80. For example, the App may analyze the image of the equipment and identify the particular piece of equipment based on its shape, size, configuration, and/or using other identifying indicia on or associated with the piece of equipment. Additionally or alternatively, the App may analyze the image of the equipment and identify the particular piece of equipment based on an ID tag (e.g., a bar code or a series of characters, letters, or numbers that are unique for each individual refrigeration case 52). Subsequently, the mobile device 80 may be configured to display the configuration, performance, and operational data of the detected refrigeration case 52 on a display of the mobile device 80.

With reference to FIG. 4B, an example embodiment of a default app state of the App that is used to receive and display the configuration, performance, and/or operational data from the server of the refrigeration system is shown. In this embodiment, the mobile device 80 is a smartphone. Alternatively, a laptop, PDA, or other device of the like may be used.

The default app state of the App is shown on the display 82 of the mobile device 80. The App may be set to the default app state when the App is initialized by opening the App on the mobile device 80. The default app state is configured to provide an operator of the mobile device 80 an interface to capture an image or scan an ID tag of refrigeration or HVAC systems located within a building or dwelling. For example, the default app state may provide a “Capture Image of Case” button 90 on the display 82 of the mobile device 80. Accordingly, once the operator selects button 90, as shown by a cartoon hand in FIG. 4B, the mobile device 80 sets the App to an image capture app state, as described below.

With reference to FIG. 4C, an example embodiment of the image capture app state of an App is shown. The App is set to the image capture app state, for example, once the user has selected the “Capture Image of Case” button 90 in the default app state, as described in FIG. 4B.

The image capture app state may be configured to provide the user the capability to capture an image of the refrigeration or HVAC system. As an example, a camera button 93 may be configured to, in response to being selected by the user, activate the camera 89 and capture an image of the refrigeration case 52. Subsequently, the App may analyze the image of the equipment and identify the particular piece of equipment based on its shape, size, configuration, and/or using other identifying indicia on or associated with the piece of equipment. In response to identifying the particular piece of equipment, the App may be set to the diagnostic report app state, as described below.

Additionally or alternatively, the image capture app state may include elements on the display 82 that assist the user in capturing the image. As an example, the image capture app state may include text instructions that assist the user in capturing an image of the refrigeration or HVAC system and thus enable the App to identify the respective piece of equipment. Specifically, the display 82 may provide textual instructions that instruct the user to align the bottom corners of the refrigeration case with dashed reference lines 94, as shown in FIG. 4C.

With reference to FIG. 4D, an example embodiment of the default app state of the App used to receive and display the configuration, performance, and/or operational data from the server of the refrigeration system is shown. The default app state of the App is identical to the default app state described in FIG. 4B, but in this embodiment, the default app state includes a “Scan Case ID” button 92 and, as shown by a cartoon hand in FIG. 4D, the mobile device 80 sets the App to a scan ID app state in response to selecting button 92, as described below.

With reference to FIG. 4E, an example embodiment of the scan ID app state is shown. The App is set to the scan ID app state, for example, once the user has selected the “Scan Case ID” button 92 in the default app state, as described in FIG. 4D. The scan ID app state may be configured to provide the user the capability to capture an image of the refrigeration or HVAC system. As an example, the camera button 93 may be configured to, in response to being selected by the user, activate the camera 89 and capture an image of the ID tag (e.g., a bar code or a series of characters, letters, or numbers that are unique for each individual refrigeration case 52) of the refrigeration case 52. Subsequently, the App may analyze the image of the ID tag and identify the particular piece of equipment based on the unique configuration of the tag that is associated with a particular piece of equipment. In response to identifying the particular piece of equipment, the App may be set to the diagnostic report app state, as described below.

Additionally or alternatively, the scan ID app state may include elements on the display 82 that assist the user in capturing the ID tag. As an example, the scan ID app state may include text instructions that assist the user in capturing an image of the refrigeration or HVAC system and thus enable the App to identify the respective piece of equipment. Specifically, the display 82 may provide textual instructions that instruct the user to align the ID tag with a dashed reference box 96, as shown in FIG. 4E.

With reference to FIG. 4F, an example embodiment of a diagnostic report app state of an App that is used to receive and display the configuration, performance, and operational data from the server of the refrigeration system is shown. The App is set to the diagnostic report app state, for example, once the App has identified the particular piece of equipment of the refrigeration or HVAC system.

The diagnostic report app state may be configured to display a variety of system diagnostics, including: a health indicator score for the refrigeration system and/or a refrigeration system component; a predicted power consumption based on performance coefficients for the refrigeration system components and operational data for the refrigeration system; a benchmark power consumption based on the refrigeration system performance during a predetermined time period, such as an initialization period; a floodback condition of the refrigeration system; and a prediction of a performance or capacity issue for a future time period.

Additionally or alternatively, the diagnostic report app state may be configured to allow an operator to perform automatic setup operations for system components based on retrieved component information.

The “Back” button 88 on the display 82 of the mobile device may be configured to allow the operator to return to either the default app state. The operator of the mobile device 80 may select this button if he or she has selected the wrong refrigeration or HVAC unit, has reviewed the diagnostic report and performed any automatic setup operations for the system, or desires to set the App to the default app state.

With reference to FIG. 4G, a flowchart of example operation in providing an interface and diagnostic report of a refrigeration unit to a mobile device is shown. The control algorithm 400 may be performed, for example, by the mobile device 80 and starts at 402. At 404, a user of the mobile device 80 initializes the App and the camera 89 of the mobile device 80. The user may initialize the App, for example, by selecting the App from a list of Apps on a graphic user interface of the mobile device, such as a touchscreen of the mobile device 80.

At 406, the control algorithm 400 selects a refrigeration case identification method. As an example, the user may select the “Capture Image of Case” button 90 or the “Scan Case ID” button 92 in order to determine the method of identification. At 408, the control algorithm 400 determines whether the user selected the ID tag option (i.e., button 92). If so, the control algorithm 400 proceeds to 410; otherwise, the control algorithm 400 proceeds to 414. At 410, the mobile device 80 provides an interface instructing the user to align the case ID tag with the dashed reference box 96, and at 412, the user aligns the case ID tag with the dashed reference box 96. At 414, the mobile device 80 provides an interface instructing the user to align the refrigeration case with dashed reference lines 94, and at 416, the user aligns the bottom corners of the refrigeration case with the dashed reference lines 94.

At 418, the control algorithm 400 searches for matching refrigeration cases in, for example, the server 72 that is in communication with the mobile device 80. At 420, the control algorithm 400 determines whether the mobile device 80 detected a matching refrigeration case based on the image of the refrigeration case or the ID tag of the refrigeration case. If so, the control algorithm 400 proceeds to 424; otherwise, the control algorithm 400 proceeds to 422. At 422, the control algorithm 400 provides, using the mobile device 80, an interface instructing the user that no refrigeration case corresponding to the image or the ID tag of the refrigeration case was found and then proceeds to 406. At 424, the control algorithm 400, using the mobile device 80, provides an interface and/or diagnostic report associated with the identified refrigeration system component. As described above, the interface and/or diagnostic report may be provided on the display 82 of the mobile device 80 at the diagnostic report app state. At 426, the control algorithm 400 ends.

Once the interface is displayed on the mobile device 80, the mobile device 80 may receive input from the user via the touch screen, for example, to modify configuration data, such as setpoints for the associated refrigeration system component. The modifications can then be communicated from the mobile device 80 to the server 72 and then to the system controller 70. The system controller 70 can then update the configuration data settings for the refrigeration system and the associated refrigeration system component in particular so that the system operates with the new configuration setting or settings. In this way, a user of the mobile device 80 can view and modify configuration data for a particular refrigeration system component without having to enter such modifications directly into the system controller 70 or a particular component controller, such as the rack controller 30, case controller 62, condensing unit controller 48, and/or compressor controller 20.

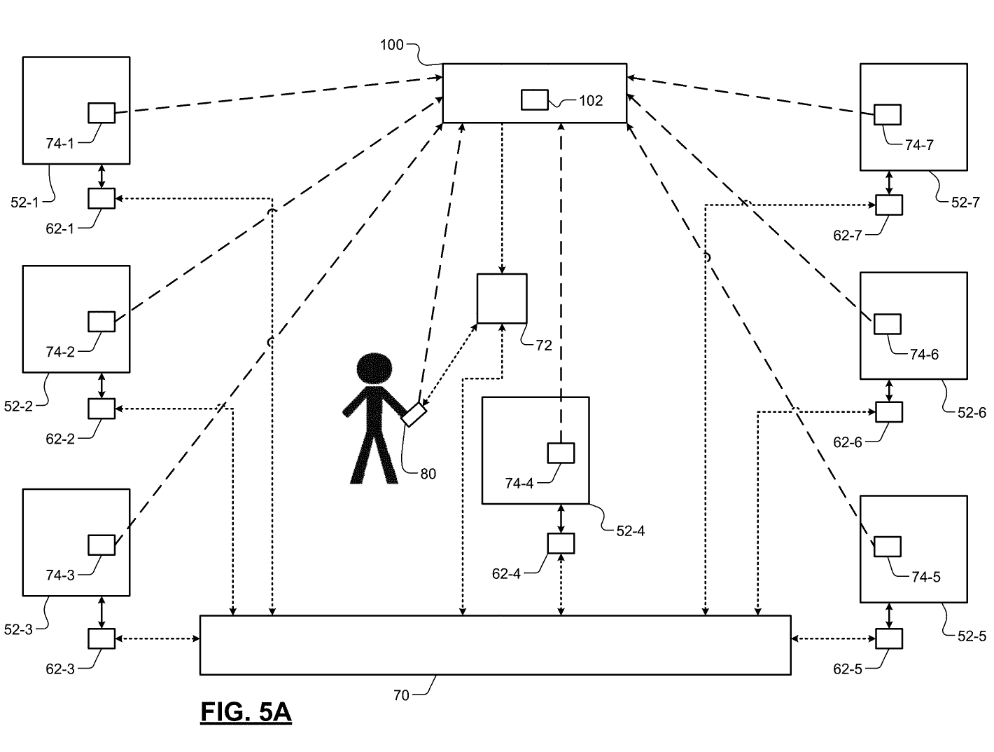

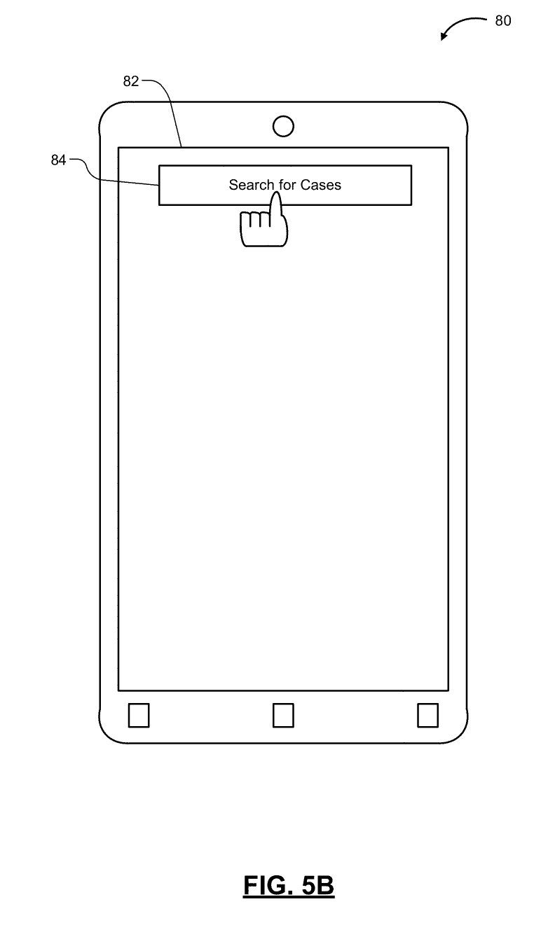

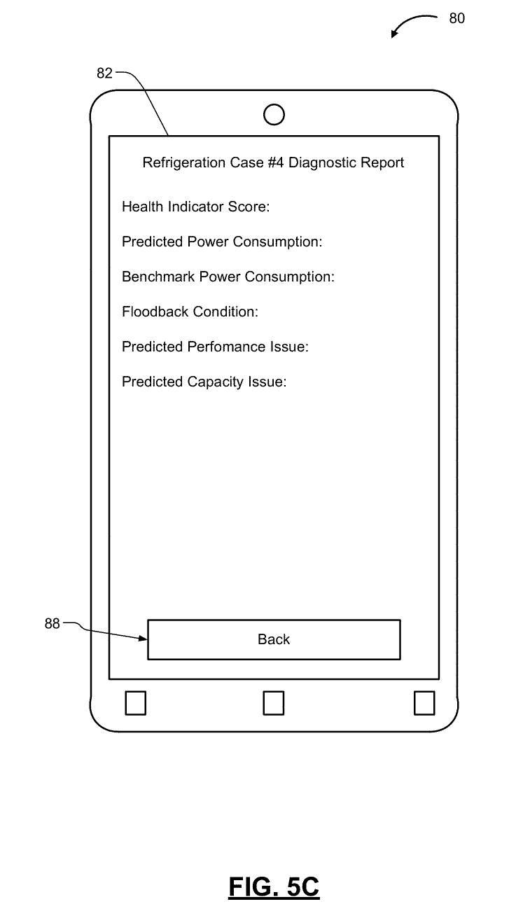

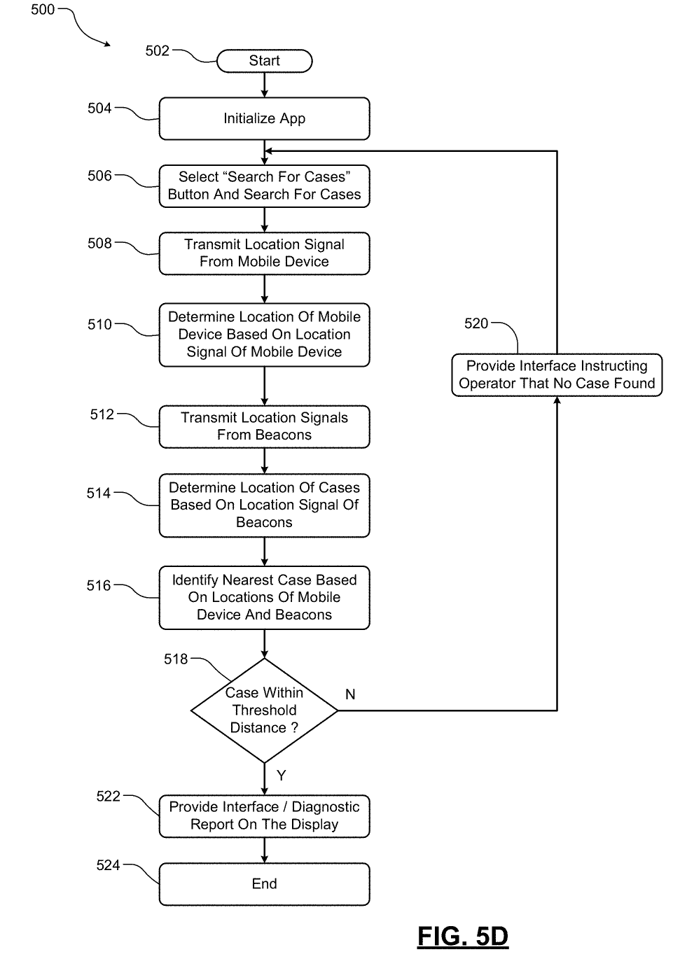

With reference to FIG. 5A, a high level diagram of another example embodiment of a location-based diagnostic view system is shown. This embodiment is similar to the embodiment described in FIG. 3A, as each refrigeration case 52-1, 52-2, . . . 52-7 (collectively referred to as refrigeration cases 52) includes a respective beacon 74-1, 74-2, . . . 74-7 (collectively referred to as beacons 74), but in this embodiment, each refrigeration case 52 includes a respective case controller 62-1, 62-2, . . . 62-7 (collectively referred to as case controllers 62), and the location-based diagnostic view system also includes a reference transceiver system 100. Alternatively, the case controllers 62 may be omitted, and the system controller 70 may directly control and monitor the refrigeration cases 52.

The reference transceiver system 100 is configured to receive a location signal from each of the beacons 74 of the respective refrigeration cases 52 and from the mobile device 80. The location signals include the identification information and/or physical location data of each of the refrigeration cases 52 and the mobile device 80.

In response to the reference transceiver system 100 receiving the location signals, a reference transceiver controller 102, which may include a processor that is configured to execute instructions stored in a non-transitory memory, determines the position of each of the refrigeration cases 52 and the mobile device 80. The reference transceiver controller 102 may be configured to determine the position of each refrigeration case 52 and the mobile device 80 based on a received signal strength of each signal (e.g., a power ratio in decibels of the reference signals (dBm), a power spectral density of the reference signals (dBm/MHz), and/or a bit error rate (BER) of the location signal) and/or an angle of arrival (AoA) of each location signal.

Then, the reference transceiver controller 102 may identify the nearest refrigeration case with respect to the operator based on the location of each refrigeration case 52 and the mobile device 80. As an example and as shown in FIG. 5A, based on the location of each refrigeration case 52 and the mobile device 80, the reference transceiver controller 102 has identified the nearest refrigeration case to be refrigeration case 52-4. In response to identifying the nearest refrigeration case with respect to the operator, the reference transceiver system 100, using the reference transceiver controller 102, may transmit a signal to the server 72 that includes information identifying the nearest refrigeration case (i.e., refrigeration case 52-4). Once the server 72 receives the signal indicating the nearest refrigeration case, the mobile device 80 is configured to, using an App, retrieve the configuration, performance, and/or operational data from the server 72 of the nearest refrigeration case (i.e., refrigeration case 52-4) and subsequently display the configuration, performance, and operational data on the display of the mobile device 80.

With reference to FIG. 5B, an example embodiment of a default app state of an App that is used to receive and display the configuration, performance, and/or operational data from the server of the refrigeration system is shown. FIG. 5B is identical to the default app state described above in FIG. 3B. In this embodiment, the mobile device 80 is a smartphone. Alternatively, a laptop, PDA, or other device of the like may be used. The default app state may provide a “Search for Cases” button 84 on the display 82 of the mobile device 80. Accordingly, once the operator selects button 84, as shown by a cartoon hand in FIG. 5B, the mobile device 80 searches for the nearest refrigeration case based on the location signals of each of the refrigeration cases 52 and the mobile device 80.

With reference to FIG. 5C, an example embodiment of a diagnostic report app state of an App that is used to receive and display the configuration, performance, and operational data from the server of the refrigeration system is shown. The App is set to the diagnostic report app state, for example, once the user has selected the “Search for Cases” button 84 in the default app state, as described in FIG. 5B, and once the mobile device 80 has retrieved the diagnostic data corresponding to the nearest refrigeration case, as described below in FIG. 5D.

The diagnostic report app state may be configured to display a variety of system diagnostics, including: a health indicator score for the refrigeration system and/or a refrigeration system component; a predicted power consumption based on performance coefficients for the refrigeration system components and operational data for the refrigeration system; a benchmark power consumption based on the refrigeration system performance during a predetermined time period, such as an initialization period; a floodback condition of the refrigeration system; and a prediction of a performance or capacity issue for a future time period. Additionally or alternatively, the diagnostic report app state may be configured to allow an operator to perform automatic setup operations for system components based on retrieved component information.

The “Back” button 88 on the display 82 of the mobile device may be configured to allow the operator to return to either the default app state. The operator of the mobile device 80 may select this button if he or she has reviewed the diagnostic report and performed any automatic setup operations for the system or desires to set the App to the default app state.

With reference to FIG. 5D, a flowchart of example operation in providing an interface and diagnostic report of a refrigeration unit to a mobile device is shown. The control algorithm 500 may be performed, for example, by the mobile device 80 and starts at 502. At 504, a user of the mobile device 80 initializes the App of the mobile device 80. The user may initialize the App, for example, by selecting the App from a list of Apps on a graphic user interface of the mobile device, such as a touchscreen of the mobile device 80.

At 506, the operator selects the “Search for Cases” button 84 on the display 82, and in response, the mobile device 80 is configured to search for the nearest refrigeration case. At 508, the mobile device 80 transmits a location signal, which may be a Bluetooth signal, to the reference transceiver system 100. At 510, the control algorithm 500, using the reference transceiver controller 102, determines the location of the mobile device 80 based on, for example, the received signal strength or the AoA of the location signal. At 512, each of the beacons 74 of the refrigeration cases transmits a location signal, which may be a Bluetooth signal, to the reference transceiver system 100. At 514, the control algorithm 500, using the reference transceiver controller 102, determines the location of each refrigeration case based on, for example, the received signal strength or the AoA of the respective location signal.

At 516, the control algorithm 500, using the reference transceiver controller 102, identifies the nearest refrigeration case based on the location of the mobile device 80 and of each the refrigeration cases 52. At 518, the control algorithm 500 determines whether the identified nearest refrigeration case is within a threshold distance. As an example, the threshold distance may be set at a value corresponding to a maximum distance that one would be able to see the respective refrigeration case 52 without any obstruction to his or her view or without any visual aids, thereby preventing the operator from identifying the refrigeration case 52 of the building that he or she cannot readily locate. If the identified nearest refrigeration case 52 is within the threshold distance, the control algorithm 500 proceeds to 522; otherwise, the control algorithm 500 proceeds to 520 and provides an interface on the mobile device 80 instructing the operator that no refrigeration case 52 was found. Then, the control algorithm proceeds to 506.

At 522, the operator of the mobile device 80 is provided an interface and/or diagnostic report associated with the identified nearest refrigeration case. As described above, the interface and/or diagnostic report may be provided on the display 82 of the mobile device 80 at the diagnostic report app state. At 524, the control algorithm 500 ends.

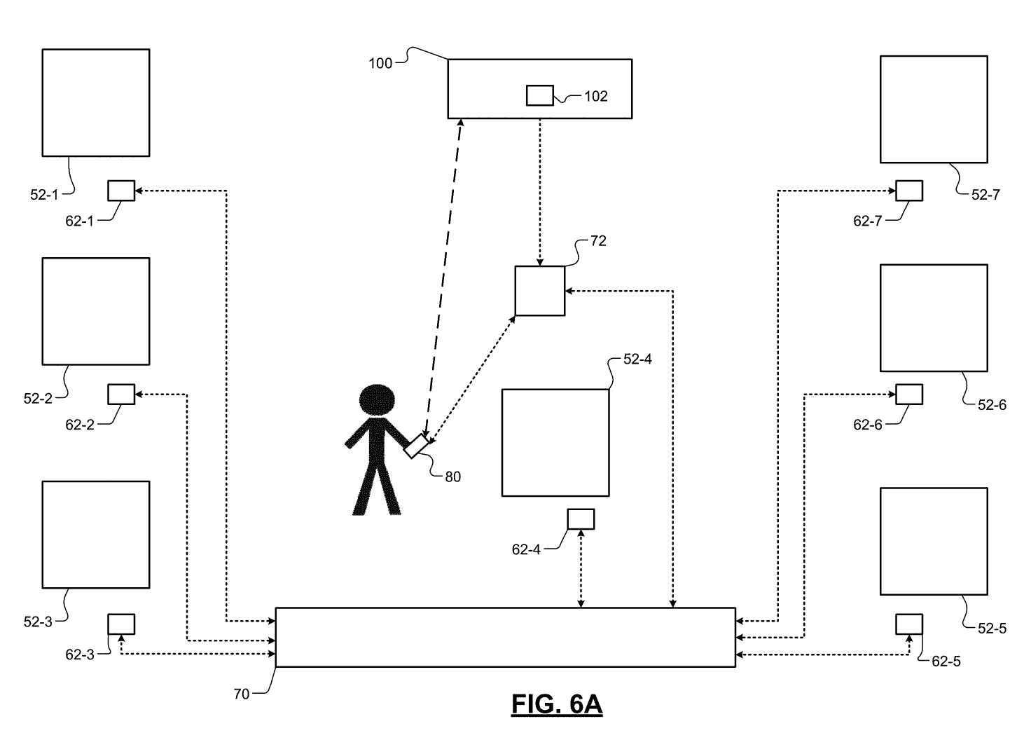

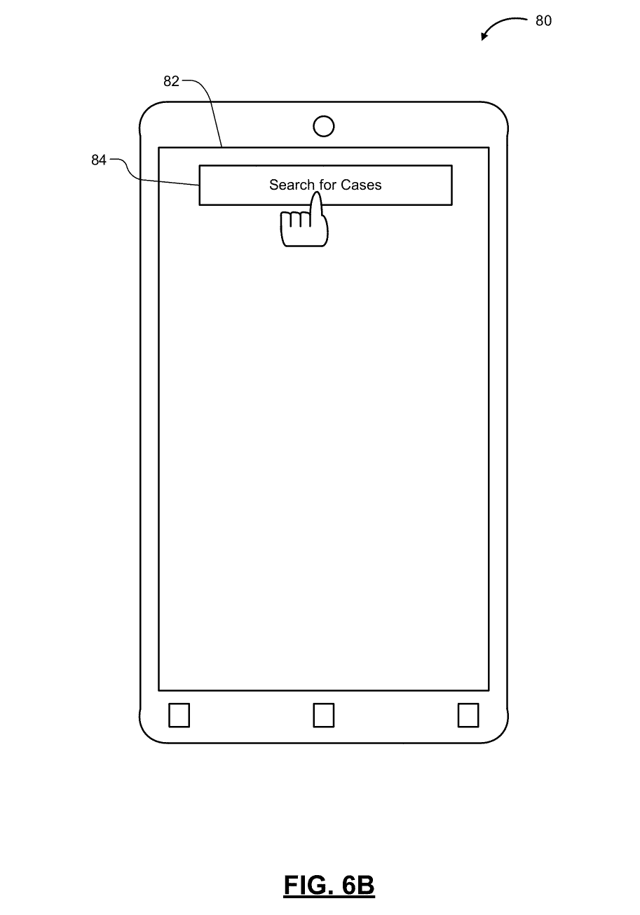

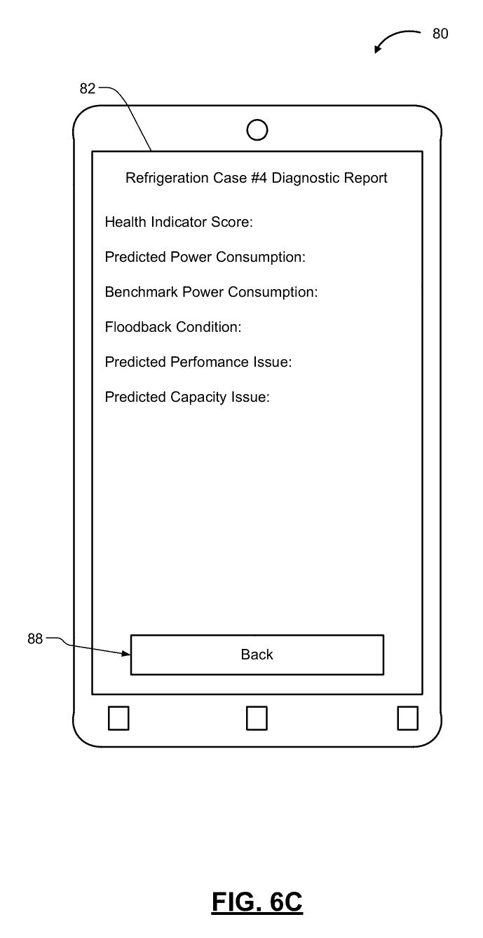

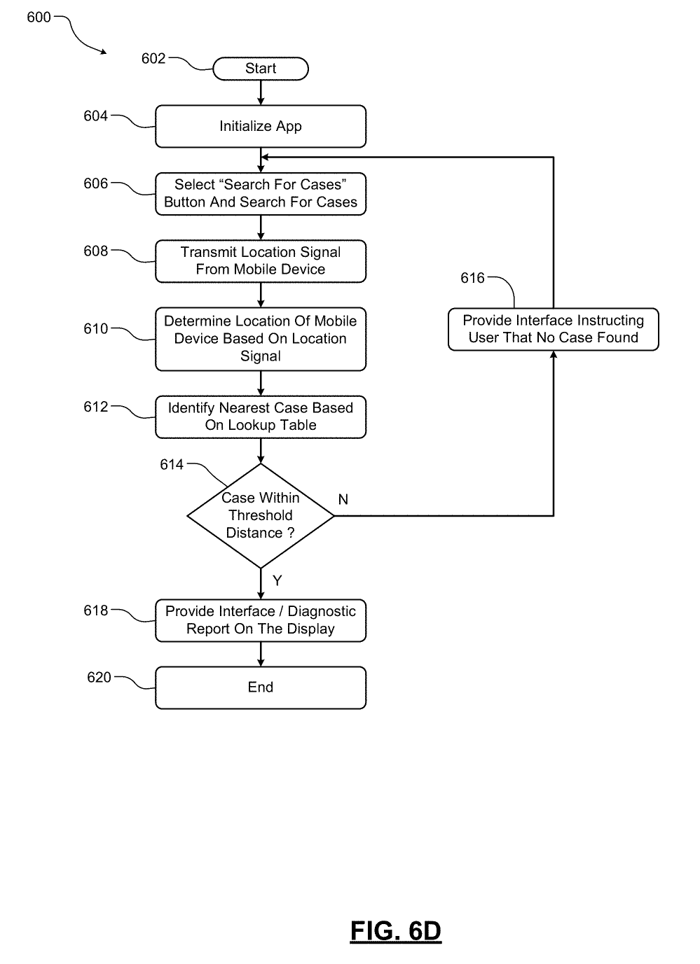

With reference to FIG. 6A, a high level diagram of another example embodiment of a location-based diagnostic view system is shown. This embodiment is similar to the embodiment described in FIG. 5A, as each refrigeration case 52-1, 52-2, . . . 52-7 (collectively referred to as refrigeration cases 52) includes a respective case controller 62-1, 62-2, . . . 62-7 (collectively referred to as case controllers 62), the reference transceiver system 100, and the reference transceiver controller 102. Alternatively, the case controllers 62 may be omitted, and the system controller 70 may directly control and monitor the refrigeration cases 52.

Similar to the embodiment described in FIG. 5A, the reference transceiver system 100, using the reference transceiver controller 102, is configured to determine the location of the mobile device 80 based on, for example, the received signal strength or the AoA of the location signal transmitted from the mobile device 80. Subsequently, the reference transceiver system 100 transmits the location data of the mobile device 80 to the server 72.

Once the server 72 receives the location data of the mobile device 80, the mobile device 80 is configured to, using an App, retrieve the configuration, performance, and/or operational data from the server 72 of the nearest refrigeration case (i.e., refrigeration case 52-4) and subsequently display the configuration, performance, and operational data on the display of the mobile device 80. In order to identify the nearest refrigeration case with respect to the operator, the mobile device 80 may be configured to compare the location data of the mobile device to the location of each refrigeration case 52, which is stored on the server 72. The location of each of the refrigeration cases 52 may be set or determined during a calibration process of the location-based diagnostic view system. Additionally or alternatively, the location data of the corresponding refrigeration case 52 may be updated and stored on the server in response to the location of the corresponding refrigeration case 52 changing to a second value that is different from the value set during the calibration process.

As an example and as shown in FIG. 6A, based on the location of each refrigeration case 52 and the mobile device 80, the reference transceiver controller 102 has identified the nearest refrigeration case to be refrigeration case 52-4. In response to identifying the nearest refrigeration case with respect to the operator, the mobile device 80 is configured to, using an App, retrieve the configuration, performance, and/or operational data from the server 72 of the nearest refrigeration case (i.e., refrigeration case 52-4) and subsequently display the configuration, performance, and operational data on the display of the mobile device 80.

With reference to FIG. 6B, an example embodiment of a default app state of an App that is used to receive and display the configuration, performance, and/or operational data from the server of the refrigeration system is shown. FIG. 6B is identical to the default app state described above in FIG. 5B. In this embodiment, the mobile device 80 is a smartphone. Alternatively, a laptop, PDA, or other device of the like may be used. The default app state may provide a “Search for Cases” button 84 on the display 82 of the mobile device 80. Accordingly, once the operator selects button 84, as shown by a cartoon hand in FIG. 6B, the mobile device 80 searches for the nearest refrigeration case based on the location signals of each of the refrigeration cases 52 and the mobile device 80.

With reference to FIG. 6C, an example embodiment of a diagnostic report app state of an App that is used to receive and display the configuration, performance, and operational data from the server of the refrigeration system is shown. The App is set to the diagnostic report app state, for example, once the user has selected the “Search for Cases” button 84 in the default app state, as described in FIG. 6B, and once the mobile device 80 has retrieved the diagnostic data corresponding to the nearest refrigeration case, as described below in FIG. 6D.

The diagnostic report app state may be configured to display a variety of system diagnostics, including: a health indicator score for the refrigeration system and/or a refrigeration system component; a predicted power consumption based on performance coefficients for the refrigeration system components and operational data for the refrigeration system; a benchmark power consumption based on the refrigeration system performance during a predetermined time period, such as an initialization period; a floodback condition of the refrigeration system; and a prediction of a performance or capacity issue for a future time period. Additionally or alternatively, the diagnostic report app state may be configured to allow an operator to perform automatic setup operations for system components based on retrieved component information.

The “Back” button 88 on the display 82 of the mobile device may be configured to allow the operator to return to either the default app state. The operator of the mobile device 80 may select this button if he or she has reviewed the diagnostic report and performed any automatic setup operations for the system or desires to set the App to the default app state.

With reference to FIG. 6D, a flowchart of example operation in providing an interface and diagnostic report of a refrigeration unit to a mobile device is shown. The control algorithm 600 may be performed, for example, by the mobile device 80 and starts at 602. At 604, a user of the mobile device 80 initializes the App of the mobile device 80. The user may initialize the App, for example, by selecting the App from a list of Apps on a graphic user interface of the mobile device, such as a touchscreen of the mobile device 80.

At 606, the operator selects the “Search for Cases” button 84 on the display 82, and in response, the mobile device 80 is configured to search for the nearest refrigeration case. At 608, the mobile device 80 transmits a location signal, which may be a Bluetooth signal, to the reference transceiver system 100. At 610, the control algorithm 600, using the reference transceiver controller 102, determines the location of the mobile device 80 based on, for example, the received signal strength or the AoA of the location signal. At 612, the control algorithm 600 identifies the nearest refrigeration case based on the location of the mobile device 80 and of each the refrigeration cases 52.

At 614, the control algorithm 600 determines whether the identified nearest refrigeration case is within a threshold distance. As an example, the threshold distance may be set at a value corresponding to a maximum distance that one would be able to see the respective refrigeration case 52 without any obstruction to his or her view or without any visual aids, thereby preventing the operator from identifying the refrigeration case 52 of the building that he or she cannot readily locate. If the identified nearest refrigeration case is within the threshold distance, the control algorithm 600 proceeds to 618; otherwise, the control algorithm 600 proceeds to 616 and provides an interface on the mobile device 80 instructing the operator that no refrigeration case 52 was found. Then, the control algorithm proceeds to 606.

At 618, the operator of the mobile device 80 is provided an interface and/or diagnostic report associated with the identified nearest refrigeration case. As described above, the interface and/or diagnostic report may be provided on the display 82 of the mobile device 80 at the diagnostic report app state. At 620, the control algorithm 600 ends.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. As used herein, the phrase at least one of A, B, and C should be construed to mean a logical (A or B or C), using a non-exclusive logical OR. It should be understood that one or more steps within a method may be executed in different order (or concurrently) without altering the principles of the present disclosure.

In this application, including the definitions below, the term module may be replaced with the term circuit. The term module may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term code, as used above, may include software, firmware, and/or microcode, and may refer to programs, routines, functions, classes, and/or objects. The term shared processor encompasses a single processor that executes some or all code from multiple modules. The term group processor encompasses a processor that, in combination with additional processors, executes some or all code from one or more modules. The term shared memory encompasses a single memory that stores some or all code from multiple modules. The term group memory encompasses a memory that, in combination with additional memories, stores some or all code from one or more modules. The term memory may be a subset of the term computer-readable medium. The term computer-readable medium does not encompass transitory electrical and electromagnetic signals propagating through a medium, and may therefore be considered tangible and non-transitory. Non-limiting examples of a non-transitory tangible computer readable medium include nonvolatile memory, volatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

What is claimed is:

1. A system comprising:
a system controller for a refrigeration or HVAC system having at least one system component;
at least one transmitter beacon associated with the at least one system component and configured to broadcast a signal with information identifying the associated at least one system component; and
a mobile device configured to receive the signal, identify the at least one system component that is closest to the mobile device based on the information from the signal identifying the associated at least one system component, and retrieve at least one of configuration and operational data associated with the at least one system component based on the information from the signal identifying the associated at least one system component through communication with a server that is in communication with the system controller.

2. The system of claim 1, wherein the mobile device is configured to modify the configuration data of the at least one system component of the HVAC or refrigeration system.

3. The system of claim 2, wherein the configuration data includes a setpoint for the at least one system component.

4. The system of claim 1, wherein the signal broadcasted by the at least one transmitter beacon is a radio frequency signal utilizing a predetermined protocol.

5. The system of claim 1, wherein the mobile device is configured to receive performance data of the at least one system component.

6. The system of claim 1, wherein the mobile device is configured to receive a diagnostic report of the at least one system component, and the diagnostic report includes at least one of a health indicator score, a predicted power consumption, a benchmark power consumption, a floodback condition, a predicted performance issue, and a predicted capacity issue.

7. A method comprising:
broadcasting, with at least one transmitter beacon associated with at least one system component of a refrigeration or HVAC system, a signal with information identifying the associated at least one system component;
receiving, with a mobile device, the signal;
identifying, with the mobile device, the at least one system component that is closest to the mobile device based on the information from the signal identifying the associated at least one system component; and
retrieving, with the mobile device, at least one of configuration and operational data associated with the at least one system component based on the information from the signal identifying the associated at least one system component through communication with a server that is in communication with a system controller of the refrigeration or HVAC system.

8. The method of claim 7, further comprising modifying, with the mobile device, the configuration data of the at least one system component of the HVAC or refrigeration system.

9. The method of claim 8, wherein the configuration data includes a setpoint for the at least one system component.

10. The method of claim 7, wherein the signal broadcasted by the at least one transmitter beacon is a radio frequency signal utilizing a predetermined protocol.

11. The method of claim 7, further comprising receiving, with the mobile device, performance data of the at least one system component.

12. The method of claim 7, further comprising receiving, with the mobile device, a diagnostic report of the at least one system component, wherein the diagnostic report includes at least one of a health indicator score, a predicted power consumption, a benchmark power consumption, a floodback condition, a predicted performance issue, and a predicted capacity issue.

13. A system comprising:
a system controller for a refrigeration or HVAC system having at least one system component;
a server that is in communication with the system controller and is configured to store at least one of configuration and operational data associated with the at least one system component; and
a mobile device having a camera, wherein the camera is configured to capture an image of at least one of the at least one system component, indicia associated with the at least one system component, and an ID tag of the at least one system component, and, in response to the camera capturing the image, the mobile device is configured to (i) identify a first system component of the at least one system component based on the image, and (ii) retrieve, from the server, the at least one of the configuration and the operational data associated with the first system component.

14. The system of claim 13, wherein the mobile device is configured to modify the configuration data of the first system component of the HVAC or refrigeration system.

15. The system of claim 14, wherein the configuration data includes a setpoint for the first system component.

16. The system of claim 13, wherein the mobile device is configured to receive performance data of the first system component.

17. The system of claim 13, wherein the mobile device is configured to receive a diagnostic report of the first system component, and wherein the diagnostic report includes at least one of a health indicator score, a predicted power consumption, a benchmark power consumption, a floodback condition, a predicted performance issue, and a predicted capacity issue.

18. The system of claim 13, wherein the mobile device includes a computer vision system that is configured to analyze the image and identify the first system component based on the image.

19. A method comprising:
storing, using a server that is in communication with a system controller, at least one of configuration and operational data associated with at least one system component of a refrigeration or HVAC system;
capturing, using a camera of a mobile device, an image of at least one of the at least one system component, indicia associated with the at least one system component, and an ID tag of the at least one system component;
identifying, in response to capturing the image, a first system component of the at least one system component based on the image; and
retrieving, with the mobile device and from the server, the at least one of the configuration and the operational data associated with the first system component.

20. The method of claim 19 further comprising modifying the configuration data of the first system component of the HVAC or refrigeration system.

21. The method of claim 20, wherein the configuration data includes a setpoint for the first system component.

22. The method of claim 19, wherein the mobile device is configured to receive performance data of the first system component.

23. The method of claim 19, wherein the mobile device is configured to receive a diagnostic report of the first system component, and wherein the diagnostic report includes at least one of a health indicator score, a predicted power consumption, a benchmark power consumption, a floodback condition, a predicted performance issue, and a predicted capacity issue.

24. The method of claim 19, wherein the mobile device includes a computer vision system that is configured analyze the image and identify the first system component based on the image.

25. A system comprising:
a system controller for a refrigeration or HVAC system having at least one system component, wherein the system controller is in communication with a server;
a reference transceiver system that is configured to (i) receive a location signal from a mobile device, (ii) determine a location of the mobile device based on the location signal, and (iii) broadcast a position signal with information corresponding to the location of the mobile device to the server, wherein the server is in communication with the mobile device; and
the mobile device is configured to (i) identify a first system component of the at least one system component based on the information from the position signal, wherein the first system component is closest to the mobile device, and (ii) retrieve, from the server, at least one of configuration and operational data associated with the first system component.

26. The system of claim 25, wherein each system component of the at least one system component further comprises a transmitter beacon that is configured to broadcast an identification signal with information identifying the associated at least one system component.

27. The system of claim 26, wherein the reference transceiver system is configured to (i) receive the identification signal from each transmitter beacon, (ii) determine a location of each system component of the at least one system component based on the identification signal from each transmitter beacon, and (iii) broadcast a system position signal to the server, wherein the system position signal includes information corresponding to the location of each system component of the at least one system component.

28. The system of claim 26, wherein the mobile device is configured to (i) identify the first system component of the at least one system component based on the information from each system position signal.

29. The system of claim 25, wherein the mobile device is configured to modify the configuration data of the first system component of the HVAC or refrigeration system.

30. The system of claim 29, wherein the configuration data includes a setpoint for the first system component.

31. The system of claim 25, wherein the location signal broadcasted by the reference transceiver system is a radio frequency signal utilizing a predetermined protocol.

32. The system of claim 25, wherein the mobile device is configured to receive performance data of the first system component.

33. The system of claim 25, wherein the mobile device is configured to receive a diagnostic report of the at least one system component, and wherein the diagnostic report includes at least one of a health indicator score, a predicted power consumption, a benchmark power consumption, a floodback condition, a predicted performance issue, and a predicted capacity issue.

34. A method comprising:
transmitting, using a mobile device, a location signal to a reference transceiver system;
determining, using the reference transceiver system, a location of the mobile device based on the location signal;
broadcasting, using the reference transceiver system, a position signal with information corresponding to the location of the mobile device to a server;
identifying, with the mobile device, a first system component of at least one system component based on the information from the position signal, wherein the first system component is closest to the mobile device; and
retrieving, from the server and using the mobile device that is in communication with the server, at least one of configuration and operational data associated with the first system component based on the information from the position signal identifying the associated first system component.

35. The method of claim 34 further comprising broadcasting, using at least one transmitter beacon that is associated with each of the at least one system component, an identification signal with information identifying a corresponding system component of the at least one system component.

36. The method of claim 35 further comprising:
receiving, using the reference transceiver system, the identification signal from each transmitter beacon;
determining, using the reference transceiver system, a location of each system component of the at least one system component based on the identification signal from each transmitter beacon; and
broadcasting, using the reference transceiver system, a system position signal for each system component of to the server, wherein the system position signal includes information corresponding to the location of each system component of the at least one system component.

37. The method of claim 35 further comprising identifying, using the mobile device, the first system component of the at least one system component based on the information from the system position signal.

38. The method of claim 34, further comprising modifying, with the mobile device, the configuration data of the at least one system component of an HVAC or refrigeration system.

39. The method of claim 38, wherein the configuration data includes a setpoint for the first system component.

40. The method of claim 34, wherein the location signal broadcasted by the reference transceiver system is a radio frequency signal utilizing a predetermined protocol.

41. The method of claim 34, further comprising receiving, with the mobile device, performance data of the first system component.

42. The method of claim 34, further comprising receiving, with the mobile device, a diagnostic report of the first system component, wherein the diagnostic report includes at least one of a health indicator score, a predicted power consumption, a benchmark power consumption, a floodback condition, a predicted performance issue, and a predicted capacity issue.
